(19) United States
(12) Patent Application Publication
(10) Pub. No.: US 2015/0241970 A1
(43) Pub. Date: Aug. 27, 2015

(54) METHOD AND APPARATUS FOR PROVIDING HAPTIC EFFECT

(71) Applicant: Samsung Electronics Co., Ltd., Gyeonggi-do (KR)

(72) Inventors: Jin-Hyoung PARK, Gyeonggi-do (KR); Sang-Hyup Lee, Gyeonggi-do (KR)

(73) Assignee: Samsung Electronics Co., Ltd., Gyeonggi-do (KR)

(21) Appl. No.: 14/192,300

(22) Filed: Feb. 27, 2014

(51) Int. Cl. G06F 3/01; G06F 3/041; G06F 3/0346

(52) U.S. Cl. CPC G06F 3/016; G06F 3/0346; G06F 3/041

(57) ABSTRACT

A method and apparatus for providing, by an electronic device, a haptic effect using an input unit are provided. The method includes detecting a touch of the input unit on a touch screen of the electronic device, displaying a trajectory of the touch, calculating a curve angle of the touch trajectory drawn for a predetermined time period, and transmitting a haptic signal, corresponding to the curve angle, to the input unit.

### PRIORITY

This application claims priority under 35 U.S.C. §119(a) to a Korean patent application filed on Feb. 27, 2013 in the Korean Intellectual Property Office and assigned Serial No. 10-2013-0021424, the entire disclosure of which is incorporated herein by reference.

### BACKGROUND OF THE INVENTION

1. Field of the Invention

The present invention relates generally to a method and apparatus for providing a haptic effect and more particularly, to a method and apparatus for providing a haptic effect in response to a touch of an input unit, upon detection of the touch of the input unit on a touch screen.

2. Description of the Related Art

A User Interface (UI) provides temporary or permanent access to a user in order to enable communication between the user and a system, a device, or a program.

Extensive research has been conducted on advanced UIs that facilitate a user's manipulation of an electronic device. The user can readily apply an input to the electronic device or recognize an output of the electronic device through such an advanced UI.

For convenient inputs to the electronic device, the user may use an input unit such as a finger, a keyboard, a digitizer, a track ball, an electronic pen, and a stylus pen together with the electronic device.

Recently, methods of generating vibrations upon receipt of a touch input on a touch screen through a vibration device have been proposed in order to give a user a sense of manipulation similar to that provided if a physical button were pressed. Such various touch input schemes are actively being studied, and research is also conducted in order to determine ways to satisfy users' demands for new multi-sense interfaces.

### SUMMARY OF THE INVENTION

Aspects of the present invention are provided to address at least the above-mentioned problems and/or disadvantages and to provide at least the advantages described below. Accordingly, an aspect of the present invention is to provide a method and apparatus for providing a haptic effect to simulate a feeling that would normally be felt from using a virtual tool of an application, when a user uses an input unit.

Another aspect of the present invention is to provide a method and apparatus for providing a haptic effect by generating more accurate and various haptic signals according to touches from an input unit.

Another aspect of the present invention is to provide a method and apparatus for providing a haptic effect by providing a User Interface (UI) that enables a user to effectively set a haptic effect for an input unit.

In accordance with an aspect of the present invention, a method, performed by an electronic device, for providing a haptic effect using an input unit is provided. The method includes detecting a touch by the input unit on a touch screen of the electronic device, displaying a touch trajectory of the touch, calculating a curve angle of the touch trajectory drawn for a predetermined time period, and transmitting a haptic signal, corresponding to the curve angle, to the input unit.

In accordance with another aspect of the present invention, a method, performed by an electronic device, for providing a haptic effect using an input unit is provided. The method includes detecting a touch by the input unit on a touch screen of the electronic device, calculating a curve angle of a trajectory of the touch drawn for a predetermined time period, and transmitting a haptic signal, corresponding to the curve angle, to the input unit. The curve angle is an angle difference between at least two vectors, each of which represents touched position changes on a touch trajectory drawn during one of at least two time periods that make up the predetermined time period.

In accordance with another aspect of the present invention, a method for providing a haptic effect in an input unit under control of an electronic device is provided. The method includes receiving a haptic signal corresponding to a touch trajectory from the electronic device, when the input unit is moved on a touch screen of the electronic device according to a user input, and controlling an actuator of the input unit to vibrate according to the received haptic signal. The haptic signal includes information used to control a vibration according to a curve angle of the touch trajectory drawn for a predetermined time period.

In accordance with another aspect of the present invention, an apparatus for providing a haptic effect using an input unit is provided. The apparatus includes a touch screen configured to detect a touch by the input unit and to display a touch trajectory of the touch, a controller configured to calculate a curve angle of the touch trajectory drawn for a predetermined time period, and a communication unit configured to transmit a haptic signal, corresponding to the curve angle, to the input unit.

In accordance with another aspect of the present invention, an apparatus of providing a haptic effect using an input unit is provided. The apparatus includes a touch screen configured to detect a touch of the input unit on a touch screen of the electronic device, a controller configured to calculate a curve angle of a trajectory of the touch drawn for a predetermined time period, and a communication unit configured to transmit a haptic signal corresponding to the curve angle to the input unit. The curve angle is an angle difference between at least two vectors, each of which represent touched position changes on a touch trajectory drawn during one of at least two time periods that make up the predetermined time period.

In accordance with another aspect of the present invention, an input unit for providing a haptic effect under control of an electronic device is provided. The input unit includes a communication unit configured to receive a haptic signal, corresponding to a touch trajectory, from the electronic device, when the input unit is moved on a touch screen of the electronic device according to a user input, an actuator configured to vibrate, and a controller configured to control vibration of the actuator according to the received haptic signal. The haptic signal includes information used to control vibration according to a curve angle of the touch trajectory drawn for a predetermined time period.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram of an electronic device according to an embodiment of the present invention;

FIG. 2 is a front perspective view of an electronic device according to an embodiment of the present invention;

FIG. 3 is a rear perspective view of an electronic device according to an embodiment of the present invention;

FIG. 4 illustrates an input unit and internal sections of a touch screen according to an embodiment of the present invention;

FIG. 5 is a block diagram of an input unit according to an embodiment of the present invention;

FIG. 6 is a flowchart illustrating a method for providing a haptic effect in an electronic device according to an embodiment of the present invention;

FIG. 7 is a detailed flowchart illustrating a method for providing a haptic effect in an electronic device according to an embodiment of the present invention;

FIG. 8 is a flowchart illustrating a method for providing a haptic effect in an input unit according to an embodiment of the present invention;

FIGS. 9A, 9B and 9C illustrate an operation of providing a haptic effect according to a curve angle of a touch trajectory according to an embodiment of the present invention;

FIGS. 10D and 10E illustrate an operation of providing a haptic effect according to a curve angle of a touch trajectory according to an embodiment of the present invention;

FIGS. 11A to 11D illustrate an operation of calculating a curve angle of a touch trajectory according to an embodiment of the present invention;

FIG. 12 is a graph illustrating vibrations of an input unit according to a touch trajectory according to an embodiment of the present invention;

FIGS. 13A, 13B and 13C illustrate an operation of providing a haptic effect according to a touch pressure according to an embodiment of the present invention;

FIGS. 14A to 14D illustrate an operation of providing a haptic effect according to a touch speed according to an embodiment of the present invention;

FIGS. 15A and 15B are tables listing various haptic effects mapped to curve angles of touch trajectories and touch speeds according to an embodiment of the present invention;

FIG. 16 is a graph illustrating a first vibration listed in FIGS. 15A and 15B;

FIG. 17 is a graph illustrating a second vibration listed in FIGS. 15A and 15B;

FIG. 18 is a graph illustrating a third vibration listed in FIGS. 15A and 15B;

FIG. 19 is a graph illustrating a fourth vibration listed in FIGS. 15A and 15B;

FIG. 20 illustrates a haptic setting User Interface (UI) according to an embodiment of the present invention; and

FIGS. 21A and 21B illustrate haptic patterns according to an embodiment of the present invention.

### DETAILED DESCRIPTION OF EMBODIMENTS OF THE PRESENT INVENTION

The following description is made with reference to the accompanying drawings to assist in a comprehensive understanding of embodiments of the present invention as defined by the claims and their equivalents. It includes various specific details to assist in that understanding. Throughout the drawings, similar reference numerals will be understood to refer to similar parts, components, and structures.

Accordingly, those of ordinary skill in the art will recognize that various changes and modifications to the embodiments described herein can be made without departing from the scope and spirit of the invention. In addition, descriptions of well-known functions and constructions may be omitted for clarity and conciseness.

The terms and words used in the following description and claims are not limited to their dictionary meanings, but, are merely used to enable a clear and consistent understanding of the invention. Accordingly, it should be apparent to those skilled in the art that the following description of embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Use of the term “substantially” refers to a scenario in which the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide.

Embodiments of the present invention are provided to achieve at least the above-described technical aspects of the present invention. In an implementation, defined entities may have the same names, to which the present invention is not limited. Thus, embodiments of the present invention can be implemented with the same or ready modifications in a system having a similar technical background.

In embodiments of the present invention, an electronic device may cover a broad range of devices including a portable terminal, a computer, a TV, a kiosk, and the like. The electronic device may also be a device having a touch screen, a controller, and a communication unit that communicates with an input unit. A portable terminal may be, but is not limited to, any of a portable phone, a smart phone, a laptop computer, a tablet Personal Computer (PC), an e-book reader, a digital broadcasting terminal, a Personal Digital Assistant (PDA), a Portable Multimedia Player (PMP), a navigator, and the like.

In embodiments of the present invention, an input unit may be, for example, any of a finger, an electronic pen, a digitizer, a mouse, and an input interface of a game console such as a joy stick, which can provide a user input or a command to an electronic device through a touch of a touch screen in a contact manner or hovering above the touch screen in a non-contact manner.

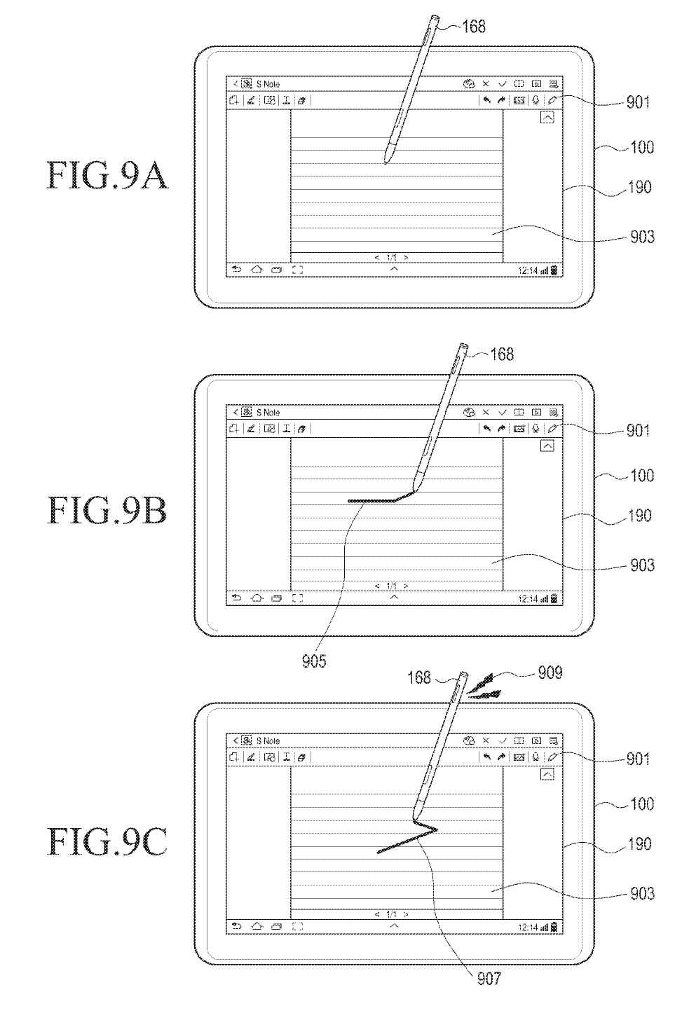

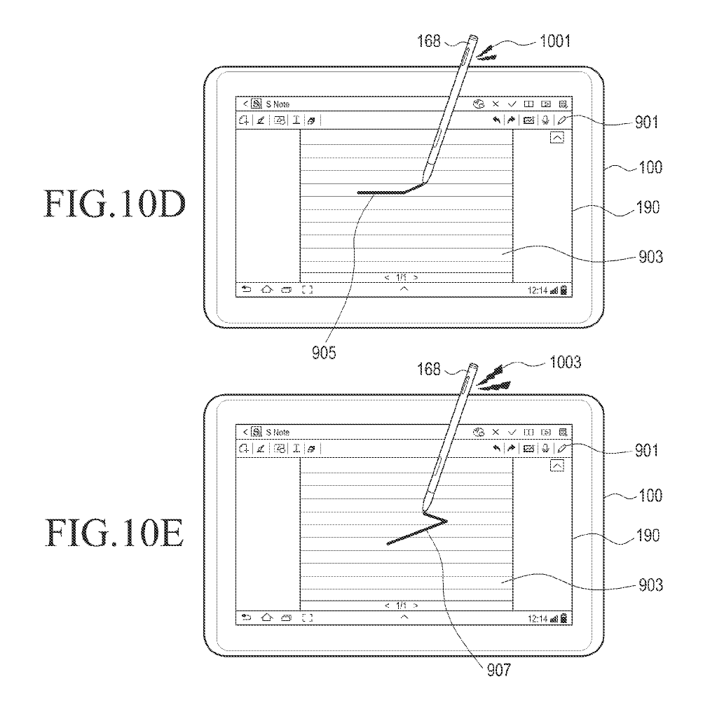

With reference to FIGS. 9A to 10E, the concept of providing a haptic effect in an electronic device by means of an input unit will be described.

In an embodiment of the present invention, an input unit includes a communication unit that receives a haptic signal from an electronic device, an actuator that generates vibrations, and a controller that controls vibration of the actuator according to the received haptic signal. The following description will be given in the context of a pen, such as an electronic pen or a stylus pen, being used as the input unit, by way of example.

The present invention is not limited to a specific pen recognition scheme and various pens operating in various manners are available in the present invention. It will be readily understood to those skilled in the art that the structure or components of a pen are determined according to the operation scheme of a touch panel that senses a pen input, that is, whether the touch panel is a pressure sensing type, a capacitive type, an electromagnetic induction type, or an Electronic Magnetic Resonance (EMR) type.

In an embodiment of the present invention, the electronic device detects a touch of the input unit, calculates a curve angle of the trajectory of the touch made for a predetermined time, and transmits a haptic signal corresponding to the curve angle to the input unit.

Referring to FIGS. 9A, 9B and 9C, when an input unit 168 (e.g., a pen) is placed on or above a touch screen 190 of an electronic device 100, the electronic device 100 may sense the touch or hovering of the input unit 168. A memo application, a drawing pad application, and the like may be executed for writing or drawing and thus displayed on the touch screen 190 in response to input from the input unit 168. For example, a writing or drawing background 903 may be displayed graphically by an application. In addition, a virtual input tool may be selected or changed by a menu of the application so that the input unit 168 may function as the virtual input tool. For example, upon selection of an object 901 in the application menu, a submenu may be displayed for a user to select a virtual input tool type, or virtual input tool types may be changed sequentially. The virtual input tool types may include, for example, a fountain pen, a marker pen, a knife, a drawing brush, a paint brush, a carving knife, and scissors. The texture of a background on which a touch trajectory is drawn may be preset in the application or may be selected or changed based on a user selection.

When a user moves the input unit 168, the electronic device 100 may display touch trajectories 905 and 907 as illustrated in FIGS. 9B and 9C, respectively. The electronic device 100 calculates a curve angle of a touch trajectory drawn for a predetermined time. The touch trajectory 905 is gently curved, whereas the touch trajectory 907 is steeply curved, relative to the touch trajectory 905. The electronic device 100 may calculate, as a curve angle, the angle between a first movement including a current touched position for a most recent time period and a second movement for a time period previous to the most recent time period. A current time is substantially the last time or most recent time of touch detection. Although the time of touching the input unit 168 on the touch screen 190 and the time of detecting the touch may be slightly different, the difference is negligible and thus the last detection time of the touch may be regarded as the current time. A touched position detected at the current time may be the most recent touched position.

The electronic device 100 may compare the curve angle with a predetermined threshold. If the curve angle is greater than or equal to the predetermined threshold, the electronic device 100 may transmit a haptic signal to the input unit 168. For example, the predetermined threshold may be 90 degrees. If the curve angle of a touch trajectory drawn for a predetermined time period, which substantially includes a current time, is less than the predetermined threshold, the electronic device 100 does not generate a haptic event and thus may not transmit a haptic signal to the input unit 168. Alternatively, if the curve angle of the touch trajectory drawn for the predetermined time period is greater than or equal to the predetermined threshold, the electronic device 100 may transmit a haptic signal to the input unit 168. Upon receipt of the haptic signal, the input unit 168 controls its actuator to vibrate, thus providing a haptic effect 909 as illustrated in FIG. 9C. The haptic effect 909 and haptic effects illustrated in other drawings are tactile feelings and are, thus, not visible, although they are visibly shown in the drawings to help with understanding of the haptic effects.

If the curve angle is greater than or equal to a predetermined threshold (e.g. 5 degrees), the electronic device 100 may transmit, to the input unit 168, a haptic signal including information that controls the input unit 168 to vibrate with a vibration strength corresponding to the curve angle. The electronic device 100 may store and manage a mapping table that maps angle ranges to vibration strengths.

TABLE 1

| Curve Angle A | Vibration Strength |
|---|---|
| 5° ≦ A < 45° | 1^{st} vibration strength |
| 45° ≦ A < 90° | 2^{nd} vibration strength |
| 90° ≦ A ≦ 180° | 3^{rd} vibration strength |

Table 1 illustrates such a mapping table, which lists vibration strengths according to curve angles. For example, if the curve angle of the touch trajectory 905 drawn for a predetermined time is 10 degrees in FIG. 10D, the electronic device 100 may transmit a haptic signal that controls the input unit 168 to vibrate with a first vibration strength. Upon receipt of the haptic signal from the electronic device 100, the input unit 168 controls the actuator to vibrate, thus providing a haptic effect 1001.

If, for example, the curve angle of the touch trajectory 907 drawn for a predetermined time is 120 degrees in FIG. 10E, the electronic device 100 may transmit a haptic signal that controls the input unit 168 to vibrate with a third vibration strength. Upon receipt of the haptic signal from the electronic device 100, the input unit 168 controls the actuator to vibrate, thus providing a haptic effect 1003.

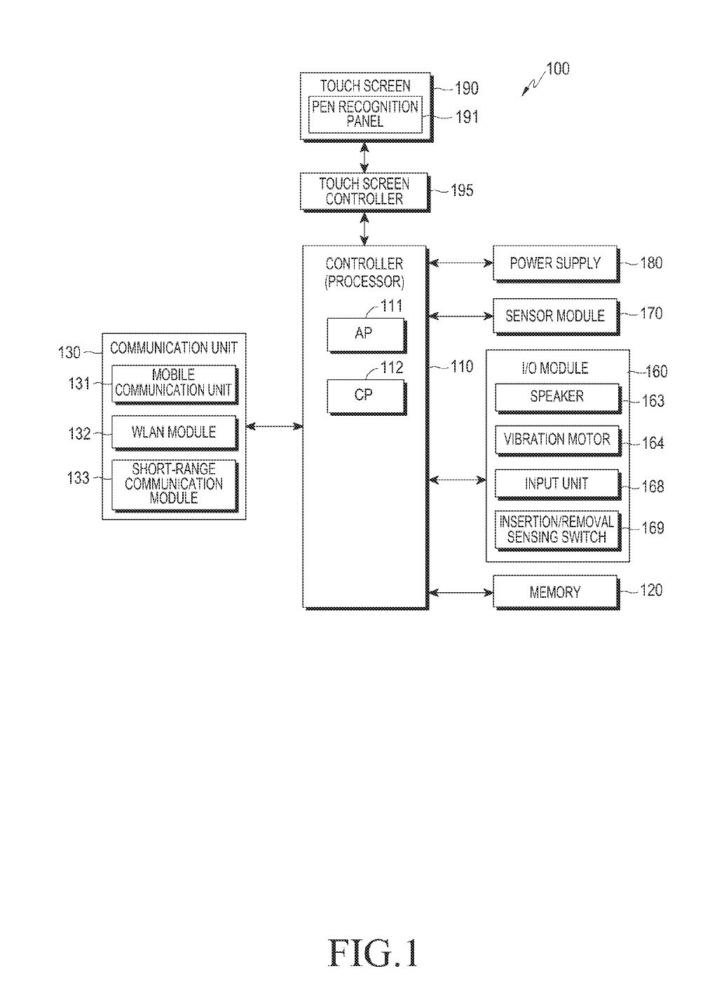

Now a description will be given of an electronic device that provides a haptic effect according to an embodiment of the present invention with reference to FIG. 1 and FIGS. 11A to 12. FIG. 1 is a block diagram of an electronic device according to an embodiment of the present invention.

Referring to FIG. 1, the electronic device 100 includes the touch screen 190, a controller 110, and a communication unit 130.

The electronic device 100 may further include a memory 120, a multimedia module 140, a camera module 150, a Global Positioning System (GPS) module 157, an Input/Output (I/O) module 160, a sensor module 170, and a power supply 180.

The touch screen 190 detects a touch of the input unit 168 and displays the trajectory of the touch. The controller 110 calculates a curve angle of a touch trajectory drawn for a predetermined time period. The communication unit 130 transmits a haptic signal. corresponding to the curve angle. to the input unit 168.

The curve angle may be the angle difference between at least two vectors representing touched position changes of the touch trajectory for at least two time periods that make up the predetermined time period. For example, the predetermined time period may be divided into an (N−1)^{th} time period and an N^{th} time period. N is an integer larger than 0. The curve angle may be the angle difference between an (N−1)^{th} vector representing touched position changes of a touch trajectory drawn for the (N−1)^{th} time period and an N^{th} vector representing touched position changes of a touch trajectory drawn for the N^{th} time period.

The haptic signal may carry information used to control the input unit 168 to vibrate with a vibration strength corresponding to the curve angle. In addition, the haptic signal may include the index of at least one haptic pattern representing a pattern of varying vibration strengths over time.

The touch screen 190 receives at least one touch input from a user's body (e.g., a finger) or the input unit 168. The touch screen 190 may include a pen recognition panel 191 that recognizes an input of a pen such as a stylus pen or an electronic pen. If the pen and the pen recognition panel 191 operate based on electromagnetic induction and the pen recognition panel 191 recognizes a pen input by electromagnetic induction, the pen recognition panel 191 may determine the distance between the pen and the touch screen 190 using a magnetic field. The pen recognition panel 191 determines the distance to the pen or touch or non-touch of the pen in a capacitive scheme. The touch screen 190 may receive a continuous movement of a single touch, among one or more touches.

The electronic device 100 further includes a touch screen controller 195. The touch screen 190 may transmit an analog signal, corresponding to a continuous movement of a touch, to the touch screen controller 195. In an embodiment of the present invention, the touch may include a non-contact touch (e.g., a detectable gap between the touch screen 190 and the user's body part or the input unit 168 is about 5 mm), not limited to contacts between the touch screen 190 and the user's body part or the input unit 168. The gap detectable to the touch screen 190 may vary according to the capabilities or configuration of the electronic device 100. Particularly, to distinguish a touch event generated by contact between the touch screen 190 and a user's body or the input unit 168 from a non-contact input event (e.g., a hovering event), the touch screen 190 may output different detection values (e.g., different analog voltage, or current, or electromagnetic force values) for the touch event and the hovering event. Further, the touch screen 190 may output a different detection value (e.g. a different current value) as a function of the distance between an area of a hovering event and the touch screen 190.

The touch screen 190 may be implemented as, for example, a resistive type, a capacitive type, an electromagnetic inductive type, an EMR type, an infrared type, or an acoustic wave type touch screen.

To receive an input of the user's body and an input of the input unit 168 simultaneously or sequentially, the touch screen 190 may include at least two touch screen panels that sense touches or a proximity of the user's body and the input unit 168, respectively. The at least two touch screen panels may provide different output values to the touch screen controller 195, which determines whether an input from the touch screen 190 is an input by the user's body or an input by the input unit 168 by distinguishing values received from the at least two touch screen panels.

The touch screen 190 may be configured by stacking a panel to sense an input of a finger or the input unit 168 by a change in inducted power and a panel to sense contact of a finger or the input unit 168 on the touch screen 190, in close contact with each other or partially apart from each other. This touch screen 190 includes a display panel. The display panel may have a large number of pixels to display an image. The display panel of the touch screen 190 may include at least one of an LCD panel, a thin-film transistor LCD panel, a flexible display panel, a three-dimensional (3D) display panel, and an electrophoretic display panel. The electronic device 100 may include two or more touch screens 190 or two or more display panels according to an embodiment of the present invention. The two or more display panels may be arranged face to face by means of a hinge.

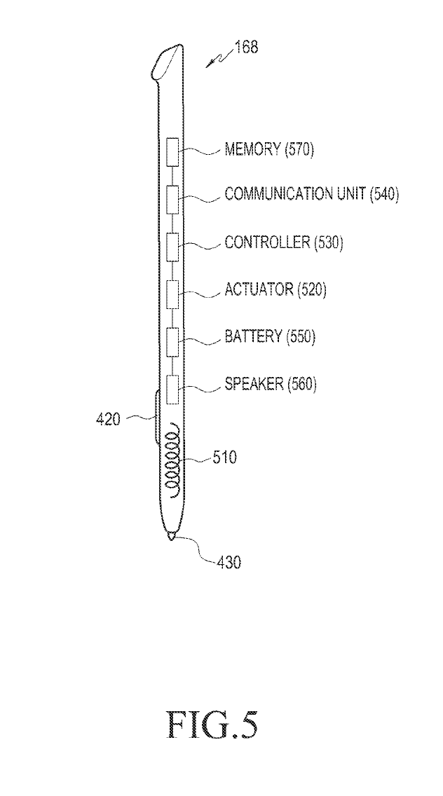

The touch screen 190 may include a single sensor module having a plurality of sensing channels, or a plurality of sensors in order to sense the position of a finger or the input unit 168 that touches or is spaced apart from the touch screen 190 by a predetermined distance. Each of the sensors may have a coil structure. In a sensor layer formed by the plurality of sensors, each sensor has a predetermined pattern and a plurality of electrode lines are formed. Thus, when a finger or the input unit 168 touches the touch screen 190, a sensing signal having a changed waveform is generated due to the capacitance between the sensor layer and the input means. The touch screen 190 transmits the sensing signal to the controller 110. The distance between the input unit 168 and the touch screen 190 may be determined based on the strength of a magnetic field formed by a coil 510 of the input unit 168 (See FIG. 5).

The touch screen controller 195 converts an analog signal, received from the touch screen 190, to a digital signal (X and Y coordinates) and transmits the digital signal to the controller 110. The controller 110 controls the touch screen 190 using the received digital signal. For example, the controller 110 may select or execute a shortcut icon (not shown) or an object displayed on the touch screen 190 in response to a touch event or a hovering event. The touch screen controller 195 may be incorporated into the controller 110.

Further, the touch screen controller 195 determines the distance between the area of a hovering event and the touch screen 190 by detecting an output value (e.g., a current value) of the touch screen 190, converts information about the distance to a digital signal (e.g. a Z coordinate), and transmits the digital signal to the controller 110.

The communication unit 130 transmits a haptic signal, generated by the controller 110, to the input unit 168. The communication unit 130 may include components that enable communication between the electronic device 100 and the input unit 168. For example, the communication unit 130 may include a short-range communication module 133 or a Wireless Local Area Network (WLAN) module 132 and transmits a haptic signal to the input unit 168 through at least one of the short-range communication module 133 and the WLAN module 132. The communication unit 130 may further include a mobile communication unit 131.

The short-range communication module 133 may include a module operating in conformance to a short-range communication standard such as, for example, Bluetooth, Zigbee, Ultra WideBand (UWB), Infrared Data Association (IrDA), Radio Frequency IDentification (RFID), Near Field Communication (NFC), or the like.

The short-range communication module 133 receives a broadcast advertising packet from the input unit 168, scans or monitors the input unit 168 at every predetermined interval or upon user request, and is paired with the scanned input unit 168 or may establish a communication channel with the input unit 168.

The WLAN module 132 may be connected to the Internet under the control of the controller 110 in a place where a wireless Access Point (AP) (not shown) is installed. The WLAN module 132 supports the WLAN standard, Institute of Electrical and Electronics Engineers (IEEE) 802.11x. The WLAN module 132 may communicate with another device having a WLAN module in the Wireless Fidelity Direct (Wi-Fi Direct) protocol. The WLAN module 132 may be included in the WLAN module 133 or its functions may be directly incorporated into the WLAN module 133.

The mobile communication unit 131 transmits and receives a radio signal to and from at least one of a base station, an external terminal, and a server over a mobile communication network. The radio signal may include various types of data such as a voice call signal, a video call signal, and a text/multimedia message. The mobile communication unit 131 may include a communication module conforming to a standard such as Global System for Mobile communication (GSM), Wideband Code Division Multiple Access (WCDMA), High Speed Downlink Packet Access (HSDPA), Long Term Evolution (LTE), Worldwide interoperability for Microwave Access (WiMAX), or the like based on a technology such as Time Division Multiplexing (TDM), Time Division Multiple Access (TDMA), Frequency Division Multiplexing (FDM), Frequency Division Multiple Access (FDMA), Code Division Multiplexing (CDM), Code Division Multiple Access (CDMA), Orthogonal Frequency Division Multiplexing (OFDM), Orthogonal Frequency Division Multiple Access (OFDMA), Multiple Input Multiple Output (MIMO), and a smart antenna technology.

The communication unit 131 may include at least one antenna, a Radio Frequency (RF) circuit, and a modem and may be configured in hardware or software. Some function module such as a modem may operate along with a Communication Processor (CP) 112 of the controller 110 or independent of the CP 112.

The controller 110 calculates a curve angle of a touch trajectory drawn for a predetermined time, generates a haptic signal corresponding to the curve angle, and controls transmission of the haptic signal to the input unit 168 through the communication unit 130.

For example, if a touch trajectory 1110, illustrated in FIG. 11A, is identical to the touch trajectory 907, illustrated in FIGS. 9C and 10E, drawn by movement of the input unit 168 on the touch screen 190 of the electronic device 100, the touch trajectory 1110 may be a solid line that starts from a starting position 1111, turns at a turning position, and ends at a current position 1112. A dotted line running from the current position 1112 to an end position 1113 indicates a possible upcoming touch trajectory.

As illustrated in FIG. 11B, the controller 110 may calculate a change in a touched position at every predetermined interval. Points 1121 to 1125 on the touch trajectory 1110 represent touched positions (or coordinates) sensed at every predetermined interval. Points 1126, 1127 and 1128 represent touched positions (or coordinates) to be sensed at every predetermined interval on the possible upcoming touch trajectory. The predetermined interval may be greater than or equal to a minimum time interval during which a touch can be sensed. For example, if the touch screen 190 senses a touch or a touched position every 1 ms, the minimum time interval for touch sensing may be lms and the predetermined interval may be set to 10 ms. Touched position changes may be expressed as a vector representing the movement distance and direction between two points per unit of time.

The controller 110 calculates a curve angle of a touch trajectory drawn for a predetermined time period. For example, the predetermined time period may span from a time of sensing the point 1123 to a time of sensing the current point 1125. FIG. 11C is an enlarged view of an area including the points 1123, 1124, and 1125 in the predetermined time period.

If the predetermined time period includes an (N−1)^{th} time period and an N^{th} time period, the (N−1)^{th} time period spans from the time of sensing the point 1123 to a time of sensing the point 1124 and the N^{th} time period spans from a time of sensing the point 1124 to the time of sensing the point 1125. Touched position changes for the (N−1)^{th} time period are represented as an (N−1)^{th} vector 1131 and touched position changes for the N^{th} time period are represented as an N^{th} vector 1133.

The controller 110 may calculate the angle difference between the (N−1)^{th} vector 1131 and the N^{th} vector 1133. For example, an angle 1145 may be calculated by moving the N^{th} vector 1133 to the starting point 1123 of the (N−1)^{th} vector 1131 in parallel or moving the (N−1)^{th} vector 1131 to the starting point 1124 of the N^{th} vector 1133 in parallel, as illustrated in FIG. 11D. Those skilled in the art will readily understand that the controller 110 may acquire the angle between the two vectors 1131 and 1133 using an equation or a function.

To calculate the curve angle of the touch trajectory, the memory 120 pre-stores the (N−1)^{th} vector 1131 before acquiring the N^{th} vector 1133. The controller 110 acquires the N^{th} vector 1133 based on the substantially current touched position 1125, at which a touch has been detected at the most current time, accesses the (N−1)^{th} vector 1131 for the (N−1)^{th} time period contiguous to the N^{th} time period in the memory 120, and then calculates the angle between the N^{th} vector 1133 and the (N−1)^{th} vector 1131.

The controller 110 may, alternatively, calculate the angle based on information about the positions or coordinates of the points 1123, 1124 and 1125 without vector representation, vector storing for respective time periods, or vector-based computation.

The controller 110 typically provides overall control to the electronic device 100. The controller 110 may control the touch screen 190, the touch screen controller 195, the communication unit 130, the multimedia module 140, the camera module 150, the GPS module 157, the I/O module 160, the sensor module 170, and the power supply 180 by executing programs stored in the memory 120.

The controller 110 includes an Application Processor (AP) 111 and the CP 112. The AP 111 controls execution of applications stored in the memory 120.

The controller 110 may include a Central Processing Unit (CPU) (not shown), a Read Only Memory (ROM) (not shown) that stores a control program to control the electronic device 100, and a Random Access Memory (RAM) (not shown) that stores signals or data received from the outside of the electronic device 100 or for use as a memory space for an operation performed by the electronic device 100. The CPU may include one or more cores. The CPU, the ROM, and the RAM may be connected to one another through an internal bus.

While a plurality of objects are displayed on the touch screen 190, the controller 110 may determine the presence or absence of a hovering input, which is generated when the input unit 168, such as an electronic pen, approaches an object from above, or may determine from data received from the touch screen 190 the presence or absence of a touch input, which is generated when the input unit 168 touches the touch screen 190. The controller 110 may determine the height of the input unit 168 above the electronic device 100 and may sense a hovering input according to the height. That is, the controller 110 senses a hovering input of the input unit 168 above the touch screen 190 or a touch input of the input unit 168 on the touch screen 190. In the present invention, the hovering input and touch input of the input unit 168 are collectively referred to as input events.

Upon generation of an input event from the input unit 168, the controller 110 senses the input event and analyzes it.

The controller 110 detects an event or movement of the input unit 168 on the touch screen 190, which displays at least one object, and generates a control signal corresponding to a predetermined haptic pattern. The control signal may include a signal that controls vibrations of the input unit 168 according to the haptic pattern. To control vibration of the input unit 168 according to a haptic pattern, the electronic device 100 pre-stores haptic patterns corresponding to instantaneous or continuous movements of the input unit 168. Each of these haptic patterns represents at least one of the type of a virtual input unit and the texture of a background on which a touch trajectory is drawn, as set by a touch trajectory display application that displays a touch trajectory of the input unit 168. The memory 120 stores the haptic patterns corresponding to the types of virtual input units or the textures of backgrounds on which touch trajectories are drawn.

The controller 110 monitors movement of the input unit 168 until the end of its continuous movement on the touch screen 190 and generates a haptic signal corresponding to the touch trajectory, touch speed, or touch pressure of the input unit 168. The haptic signal may include information used to control the input unit 168 to vibrate according to a vibration strength and a haptic pattern. The vibration strength may correspond to at least one of a curve angle of the touch trajectory, the touch pressure, and the touch speed. In addition, the haptic pattern corresponds to at least one of the type of a virtual input tool and the texture of a background on which the touch trajectory is displayed, as set by the touch trajectory display application. The controller 110 controls transmission of the haptic signal to the input unit 168 through the communication unit 130. Upon receipt of the haptic signal, the input unit 168 may vibrate according to the information included in the haptic signal. For example, the input unit 168 may vibrate by setting a vibration strength and a haptic pattern according to the control information included in the haptic signal.

The I/O module 160 may include a speaker 163, a vibration motor 164, and the input unit 168. The I/O module 160 is not limited to the configuration illustrated in FIG. 1 and may provide a cursor control such as a mouse, a track ball, a joystick, or cursor directional keys to control movement of a cursor on the touch screen 190 by communicating with the controller 110.

The speaker 163 may output an acoustic effect corresponding to a haptic signal transmitted to the input unit 168 through the communication unit 130. A sound corresponding to the haptic signal may include a sound generated by activation/deactivation of the actuator of the input unit 168 or a sound having a variable volume according to a vibration strength. The haptic signal may correspond to at least one of the type of a virtual input tool and the texture of a background on which a touch trajectory is displayed, as set by a touch trajectory display application. As the electronic device 100 provides a tactile effect or acoustic effect, corresponding to a haptic response to a touch to the user in this manner, the user may feel a realistic sensation of manipulating a virtual input tool.

The acoustic effect may be provided through a speaker of the input unit 168 together with or instead of the speaker 163 of the electronic device 100. For example, a sound volume may be controlled according to a vibration strength of an actuator 520 of the input unit 168 in FIG. 5 or a sound may be output through the speaker 163 of the electronic device 100 and/or a speaker 560 of the input unit 168, simultaneously with activation of the actuator 520 or a predetermined time (e.g., 10 ms) before or after the activation of the actuator 520. The sound may stop simultaneously with deactivation of the actuator 520 or a predetermined time (e.g., 10 ms) before or after the deactivation of the actuator 520.

The speaker 163 outputs sounds corresponding to functions (e.g., a button manipulation sound or a ringback tone in a call) performed by the electronic device 100. One or more speakers 163 may be disposed at an appropriate position or positions on the housing of the electronic device 100.

The vibration motor 164 converts an electrical signal to a mechanical vibration under the control of the controller 110. For example, when the electronic device 100 receives an incoming voice call from another device (not shown) in a vibration mode, the vibration motor 164 may operate. One or more vibration motors 164 may be mounted inside the housing of the electronic device 100. The vibration motor 164 may also operate in response to a user touch on the touch screen 190 or continuous movement of a user touch on the touch screen 190.

The vibration motor 164 may include a linear motor or a rotary motor. A device that can convert electrical energy to kinetic energy, such as an Electro Active Polymer (EAP) may be used instead of the vibration motor 164.

The input unit 168 may be configured as a part of the electronic device 100 or separately from the electronic device 100. The input unit 168 may be inserted and kept inside the electronic device 100. When the input unit 168 is used, it may be extended or removed from the electronic device 100. An insertion/removal sensing switch 169 is provided in an internal area of the electronic device 100 into which the input unit 168 is inserted, in order to operate in response to insertion and removal of the input unit 168. The insertion/removal sensing switch 169 outputs signals corresponding to insertion and removal of the input unit 168 to the controller 110. The insertion/removal sensing switch 169 may be configured so as to directly or indirectly contact the input unit 168, when the input unit 168 is inserted. Therefore, the insertion/removal sensing switch 169 outputs, to the controller 110, a signal corresponding to insertion or removal of the input unit 168 depending on whether the insertion/removal sensing switch 169 contacts the input unit 168 directly or indirectly.

The sensor module 170 includes at least one sensor to detect a state of the electronic device 100. For example, the sensor module 170 may include a proximity sensor that detects whether the user is close to the electronic device 100, an illuminance sensor (not shown) that detects the amount of ambient light around the electronic device 100, a motion sensor (not shown) that detects a motion of the electronic device 100 (e.g., rotation, acceleration or vibration of the electronic device 100), a geo-magnetic sensor that detects a point of the compass of the electronic device 100 using the earth's magnetic field, a gravity sensor that detects the direction of gravity, and an altimeter that detects an altitude by measuring the air pressure. At least one sensor detects a state of the electronic device 100, generates a signal corresponding to the detected state, and transmits the signal to the controller 110. A sensor may be added to or omitted from the sensor module 170 according to the desired functionality of the electronic device 100.

The memory 120 stores information required to provide various haptic effects to the input unit 168 or the electronic device 100, when an instantaneous or continuous touch is made on the touch screen 190 by the input unit 168. For example, the memory 120 may store vibration strength data corresponding to a curve angle of a touch trajectory, a touch pressure, or a touch speed. In addition, the memory 120 may store haptic patterns, each corresponding to at least one of the type of a virtual input tool and the texture of a background on which a touch trajectory is displayed, as set by a touch trajectory display application. In another embodiment of the present invention, the memory 120 may store haptic patterns, each corresponding to a curve angle of a touch trajectory, a touch pressure, or a touch speed.

The haptic patterns may include, for example, a haptic pattern for paper cutting, a haptic pattern for pen type changing, a haptic pattern for handwriting by a pen, and a haptic pattern corresponding to a tactile feeling that a user has experienced or may experience. In addition to these haptic patterns, the memory 120 may store user haptic settings through a UI.

The memory 120 includes the ROM and the RAM of the controller 110 or a memory card (not shown) (e.g. a Secure Digital (SD) card or a memory stick) mounted to the electronic device 100. The memory 120 may include a non-volatile memory, a volatile memory, a Hard Disk Drive (HDD), or a Solid State Drive (SSD).

The memory 120 may store applications having various functions such as navigation, video call, game, and time-based alarm applications, images used to provide Graphical User Interfaces (GUIs) related to the applications, user information, text, databases or data related to a method of processing a touch input, background images (e.g. a menu screen, a waiting screen, and the like) or operation programs required to operate the terminal 100, and images captured by the camera module 150.

The memory 120 may include a machine-readable medium (e.g. a computer-readable medium) and may access information in the machine-readable medium and stores the accessed information under the control of the controller 110. The machine-readable medium may be defined as a medium that provides data to a machine so that the machine may perform a specific function. For example, the machine-readable medium may be a storage medium. The machine-readable medium includes, but is not limited to, at least one of a floppy disk, a flexible disk, a hard disk, a magnetic tape, a Compact Disk Read Only Memory (CD-ROM), an optical disk, a punch card, a paper tape, a RAM, a Programmable ROM (PROM), an Erasable PROM (EPROM), and a Flash-EPROM.

The power supply 180 may include at least one battery (not shown) mounted in the housing of the electronic device 100, a power supply circuit, or a battery charging circuit under the control of the controller 110. The power supply 180 may supply power to the electronic device 100. In addition, the power supply 180 may supply power received from an external power source (not shown) via the cable connected to the connector 165 to the electronic device 100 or the battery. The power supply 180 may also supply power received wirelessly from an external power source to the electronic device 100 or charge the battery with the power by a wireless charging technology.

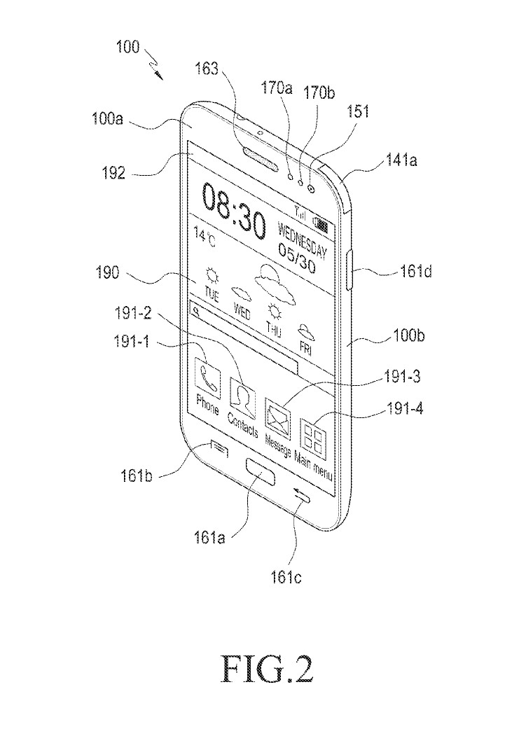

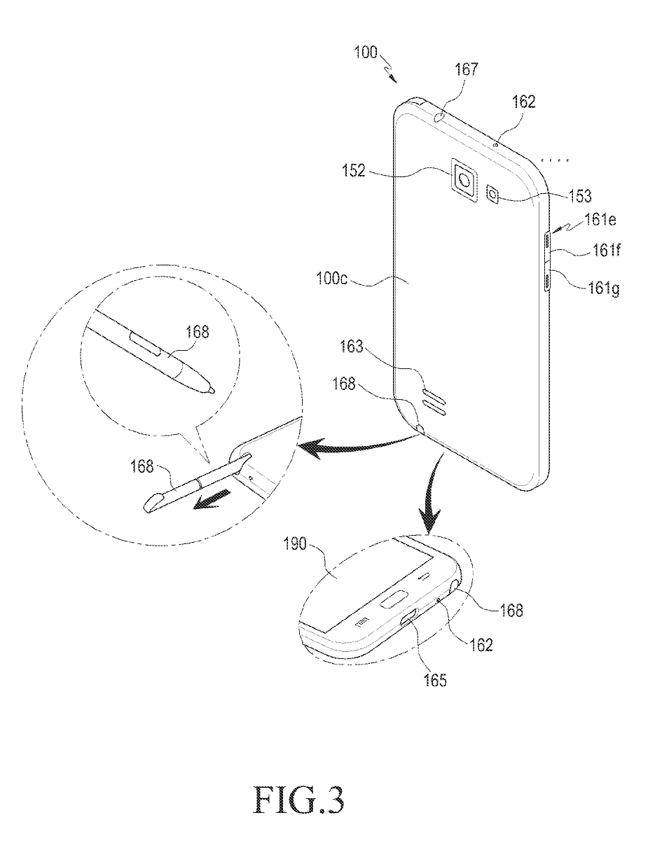

FIGS. 2 and 3 are respectively front and rear perspective views of an electronic device according to an embodiment of the present invention.

Referring to FIGS. 2 and 3, the touch screen 190 is disposed at the center of the front surface 100a of the electronic device 100, occupying almost the entirety of the front surface 100a. In FIG. 2, a main home screen is displayed on the touch screen 190, by way of example. The main home screen is the first screen to be displayed on the touch screen 190, when the electronic device 100 is powered on or screen-unlocked. In the case in which the electronic device 100 has different home screens of a plurality of pages, the main home screen may be a predetermined one of the home screens of the plurality of pages, or the last displayed home screen before a screen is turned off. Shortcut icons 191-1, 191-2 and 191-3 used to execute frequently used applications, a main menu switch key 191-4, time, weather, and the like may be displayed on the home screen. Upon user selection of the main menu switch key 191-4, a menu screen or a list of applications is displayed on the touch screen 190. A status bar 192 may be displayed at the top of the touch screen 190 in order to indicate states of the electronic device 100 such as a battery charged state, a received signal strength, and a current time.

A home button 161a, a menu button 161b, and a back button 161c may be formed at the bottom of the touch screen 190.

The home button 161a is used to display the main home screen on the touch screen 190. For example, upon selection of the home button 161a while any home screen other than the main home screen or the menu screen is displayed on the touch screen 190, the main home screen may be displayed on the touch screen 190. Upon selection of the home button 161a during execution of applications on the home screen 190, the main home screen illustrated in FIG. 2 may be displayed on the touch screen 190. The home button 161a may also be used to display recently used applications or a task manager on the touch screen 190.

The menu button 161b provides link menus (or additional menus) that can be used on the touch screen 190. The link menus may include a widget adding menu, a background changing menu, a search menu, an edit menu, an environment setting menu, and the like.

The back button 161c may display the screen previous to a current screen or end the latest used application. With the back button 161c, an application on a screen may be operated in the background and another application may be displayed on the screen.

A first camera 151, an illuminance sensor 170a, and a proximity sensor 170b may be arranged at a corner of the front surface 100a of the electronic device 100, whereas a second camera 152, a flash 153, and the speaker 163 may be arranged on the rear surface 100c of the electronic device 100.

For example, a power/reset button 160d, a volume button 161e (e.g. buttons 161f and 161g may be mapped to volume up/down functions), a terrestrial Digital Media Broadcasting (DMB) antenna 141a that receives a broadcast signal, and one or more microphones 162 may be disposed on side surfaces 100b of the electronic device 100. The DMB antenna 141a may be mounted to the electronic device 100 fixedly or detachably.

A connector 165 is formed on the bottom side surface of the electronic device 100. The connector 165 includes a plurality of electrodes. The connector 165 may be connected to an external device by wire or the electronic device 100 may be docked with the external device through the connector 165. An earphone connector jack 167 may be formed on the top side surface of the electronic device 100. An earphone may be inserted into the earphone connector jack 167.

The input unit 168 may be inserted into to the bottom side surface of the electronic device 100. The input unit 168 may be inserted and kept inside the electronic device 100. When the input unit 168 is used, the input unit 168 may be extended and removed from the electronic device 100.

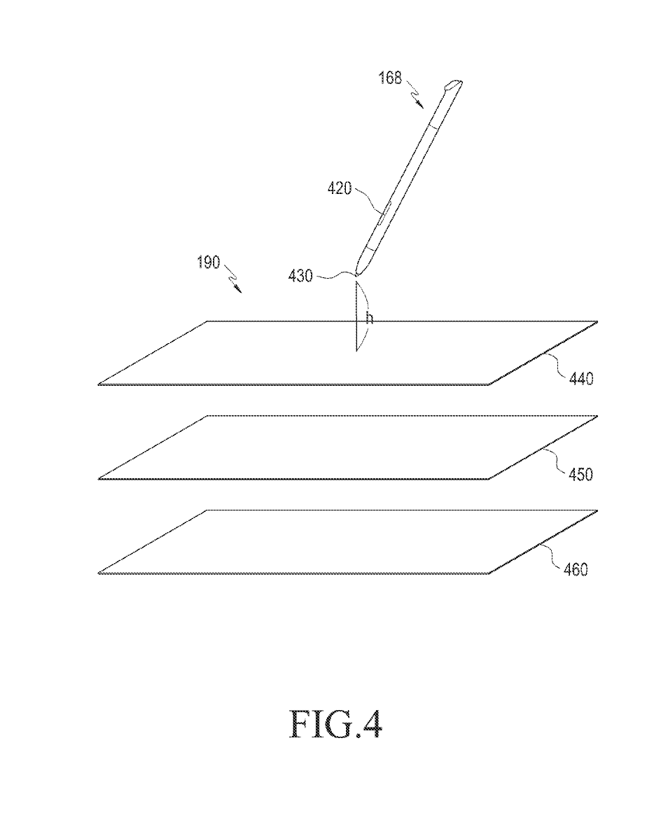

FIG. 4 illustrates an input unit and internal sections of a touch screen according to an embodiment of the present invention.

Referring to FIG. 4, the touch screen 190 may include a display panel 450, a first touch panel 440, and a second touch panel 460. Alternatively, the touch screen 190 may include the display panel 450 and one of the first and second touch panels 440 and 460. The order of the stacking the display panel 450, the first touch panel 440, and the second touch panel 460 in the touch screen 190 may be changed according to the characteristics or design of the touch panels 440 and 450 or the display panel 450.

The display panel 450 may be a Liquid Crystal Display (LCD) panel, an Active Matrix Organic Light Emitting Diode (AMOLED) panel, or the like, which displays various images according to operation states of the electronic device 100, application execution, and services, and displays a plurality of objects.

The first touch panel 440 may be a capacitive type configured using transparent electrodes. The capacitive touch panel is formed by coating thin layers of a metal conductive material (e.g. Indium Tin Oxide (ITO) layers) onto both surfaces of glass to flow current on the surfaces of the glass and coating a dielectric material to store capacitance. When an input means (e.g. a user's finger or a pen) touches on a surface of the first touch panel 440, a specific amount of charge migrates to a touched position due to static electricity. The first touch panel 440 senses the touched position by recognizing a current variation caused by the charge migration. The first touch panel 440 may sense every touch that can cause static electricity and may also sense a touch of a finger or a pen as an input means.

The second touch panel 460 is an EMR type. For example, the EMR touch panel may include an electro-inductive coil sensor (not shown) having a grid structure in which a plurality of loop coils are arranged in a predetermined first direction and a second direction perpendicular to the first direction, and an electronic signal processor (not shown) that provides an Alternating Current (AC) signal having a predetermined frequency sequentially to each loop coil of the electro-inductive coil sensor. When the input unit 168 having an built-in resonant circuit is located proximate to a loop coil of the second touch panel 460, a magnetic field transmitted from the loop coil generates current based on mutual electromagnetic induction in the resonant circuit of the input unit 168. An inductive magnetic field is generated based on the current from the coil (e.g., 510 in FIG. 5) of the resonant circuit of the input unit 168 and the second touch panel 460 detects the inductive magnetic field from a loop coil in a signal reception state, thereby detecting a hovering position, a touched position of the input unit 168, and the height h of a pen point 430 of the input unit 168 above the touch screen 190. The height h of the pen point 430 above the touch screen 190 may be defined as the height of the pen point 430 from the second touch panel 460 or the display panel 450 instead of the first touch panel 440, as illustrated in FIG. 4. A predetermined offset may be added to the height h. Those skilled in the art will readily understand that a reference or reference value for measuring the height h may vary depending on the capabilities or configuration of the electronic device 100.

The input unit 168 generates current based on electromagnetic induction through the second touch panel 460. The second touch panel 460 may sense a hovering input or a touch input based on the generated current. For example, the input unit 168 may be an electromagnetic pen or an EMR pen. The input unit 168 is different from an ordinary pen that does not include a resonant circuit sensible to the first touch panel 440. The input unit 168 may be configured to include a button 420 that may change an electromagnetic induction value caused by a coil inside a pen body proximate to the pen point 430. The input unit 168 is described later in greater detail with reference to FIG. 5.

The touch screen controller 195 may include a first touch panel controller (not shown) and a second touch panel controller (not shown). The first touch panel controller converts an analog signal corresponding to a hand touch or a pen touch, received from the first touch panel 440, to a digital signal (e.g. X, Y and Z coordinates) and may transmit the digital signal to the controller 110. The second touch panel controller converts an analog signal corresponding to a hovering or touch of the input unit 168, received from the second touch panel 460, to a digital signal and may transmit the digital signal to the controller 110. The controller 110 controls the display panel 450, the first touch panel 450, and the second touch panel 460 based on the digital signals received from the first and second touch panel controllers. For example, the controller 110 may display a predetermined screen on the display panel 450 in response to a hovering or touch of a finger, a pen, or the input unit 168.

In an embodiment of the present invention, the first touch panel 440 may sense a finger touch or a pen touch and the second touch panel 460 may sense a hovering or touch of the input unit 168 in the electronic device 100. Thus, the controller 110 of the electronic device 100 may distinguish a finger touch or a pen touch from a hovering or touch of the input unit 168. While only one touch screen is shown in FIG. 4, the present invention is not limited to a single touch screen and may have a plurality of touch screens. Each touch screen may be engaged with one housing by a hinge or a plurality of touch screens may be mounted in a single housing in the electronic device 100. As illustrated in FIG. 4, each touch screen may include a display panel and at least one touch panel.

FIG. 5 is a block diagram illustrating the input unit 168 that provides a haptic effect according to an embodiment of the present invention. The input unit 168 may be included in the electronic device 100 or configured separately from the electronic device 100. For example, if the same touch panel scheme or communication protocol is preset between the electronic device 100 and the input unit 168, the input unit 168 may be configured irrespective of manufacturing of the electronic device 100 or may be manufactured separately from the electronic device 100.

Referring to FIG. 5, the input unit 168 (e.g., a pen operating with respect to an electromagnetic inductive touch panel or an EMR touch panel) includes a communication unit 540, a controller 530, and the actuator 520. The input unit 168 may further include a memory 570, a battery 550, a speaker 560, a pen body, the pen point 430 at an end of the pen body, the coil 510, the button 420, and/or an electromagnetic inductive circuit (not shown).

When the input unit 168 touches the touch screen 190 and moves the touch on the touch screen 190 according to a user input, the communication unit 540 receives a haptic signal corresponding to the trajectory of the touch from the electronic device 100. The communication unit 540 may be paired with the electronic device 100 or may establish a communication link with the electronic device 100 by short-range communication such as Bluetooth.

The actuator 520 vibrates so that the user may feel a tactile feeling. The actuator 520 may include a device that converts electronic energy to kinetic energy, such as a vibration motor or an EAP. For example, the vibration motor may be a linear motor or a rotary motor.

The controller 530 controls vibration of the actuator 520 according to a haptic signal. The haptic signal includes information used to control vibration of the actuator 520 according to a curve angle of a touch trajectory drawn for a predetermined time period.

The memory 570 may store at least one preset haptic pattern. The controller 530 may access a haptic pattern corresponding to a haptic signal in the memory 570 and control vibration of the actuator 520 according to the accessed haptic pattern.

The coil 510 or the electromagnetic inductive circuit may be disposed in an area proximate to the pen point 430, inside the pen body. When the button 420 is manipulated, an electromagnetic induction value generated from the coil 510 or the electromagnetic inductive circuit may be changed. The electronic device 100 may sense generation of an input event, through an input of the button 420 by the user, based on the electromagnetic induction value changed to a specific value. The button 420 may be used for an input event that transmits an input signal to the electronic device 100 through the communication unit 540.

The battery 550 supplies power for vibration or communication of the input unit 168.

The speaker 560 outputs a sound corresponding to a vibration strength of the input unit 168 or a haptic pattern. The speaker 560 may output a sound corresponding to a haptic effect for the input unit 168, simultaneously with the speaker 163 of the electronic device 100 or a predetermined time (e.g. 10 ms) before or after than the speaker 163.

In addition, the speaker 560 may output sounds corresponding to various signals (e.g., a wireless signal, a broadcast signal, a digital audio file, a digital video file, etc.) of the electronic device 100 under the control of the haptic controller 530. Further, the speaker 560 may output a sound corresponding to a function executed in the electronic device 100 (e.g., a button manipulation sound or a ringback tone in a call). One or more speakers 560 may be provided at an appropriate position(s) of a housing of the input unit 168.

When the pen point 430 touches the touch screen 190 or the pen point 430 is placed at a hovering sensed position (e.g., within 5 mm above the touch screen 190), the controller 530 may analyze at least one haptic signal received from the electronic device 100 through the communication unit 540 and may control a vibration strength, a haptic pattern, and the like of the actuator 520 of the input unit 168 according to the analysis. The electronic device 100 transmits the haptic signal to the input unit 168 during a predetermined time or periodically until a touch is completed.

The haptic signal may include at least one of information required to activate the actuator 520 of the input unit 168, information about a vibration length of the input unit 168, information required to deactivate the actuator 520 of the input unit 168, and information about a total haptic effect duration. For example, if the haptic signal is about 8 bits long, is repeatedly transmitted at every predetermined interval (e.g., every 5 ms), and vibration of the input unit 168 is controlled accordingly, the user may recognize vibrations repeated at every predetermined interval. For example, the haptic signal may carry information listed in Table 2 below.

TABLE 2

| | Activation of | | Deactivation of |
|---|---|---|---|
| Field | vibration device | Vibration strength | vibration device |
| Information | 1 | 125 125 131 131 0 | 2 |

As illustrated in Table 2, the control signal includes information required to activate the actuator 520 of the input unit 168 (e.g., a vibration-on command set to 1), information about a vibration strength of the actuator 520, and information required to deactivate the actuator 520 of the input unit 168 (e.g., a vibration-off command set to 2). Transmission of the haptic signal may be changed according to a transmission cycle and transmission duration of the haptic signal. For example, the transmission duration of the haptic signal may last until the input unit 168 finishes an instantaneous or continuous touch on the touch screen 190. The vibration strengths of the actuator have strength corresponding to o to 255. Each vibration strength value of the 125, 131 and 0 indicates a vibration strength of the actuator 520. And, each of the vibration strengths (e.g., 125, 125, 131, 131 and 0) is repeatedly outputted at every predetermined interval (e.g., every 5 ms).

The memory 120 of the electronic device 100 and the memory 570 of the input unit 168 may store and manage vibration patterns such as haptic patterns having a repetition property along a time axis, i.e., periodicity. The electronic device 100 may transmit a haptic signal including the index of a specific haptic pattern to the input unit 168. The input unit 168 may access the haptic pattern, indicated by the index included in the haptic signal, in the memory 570 and may control the actuator 520 to vibrate according to the accessed haptic pattern.

The haptic signal may further include an offset for a haptic pattern along with the index of the haptic pattern. Because a haptic pattern represents vibration strengths for a predetermined time, a different vibration strength or haptic pattern may be provided to the user according to the starting point of a haptic signal, so that the user may feel a different tactile feeling. For example, if the electronic device 100 and the input unit 168 store a preset sine function sin(x) representing vibration strengths over time to create a haptic pattern, sin(x) may be the haptic pattern itself. When an offset of 90 degrees is added to the function sin(x), a different haptic pattern such as a cosine function cos(x) may be produced. In addition, a different vibration waveform may be created by using information about a starting vibration strength and an ending vibration strength along with the haptic pattern. In this manner, a haptic signal may include the index of a haptic pattern, the offset of the haptic pattern, a starting vibration strength, an ending vibration strength, a vibration-on command, and/or a vibration-off command.

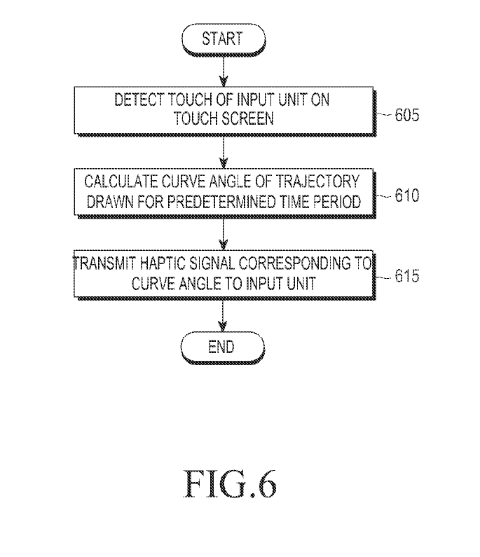

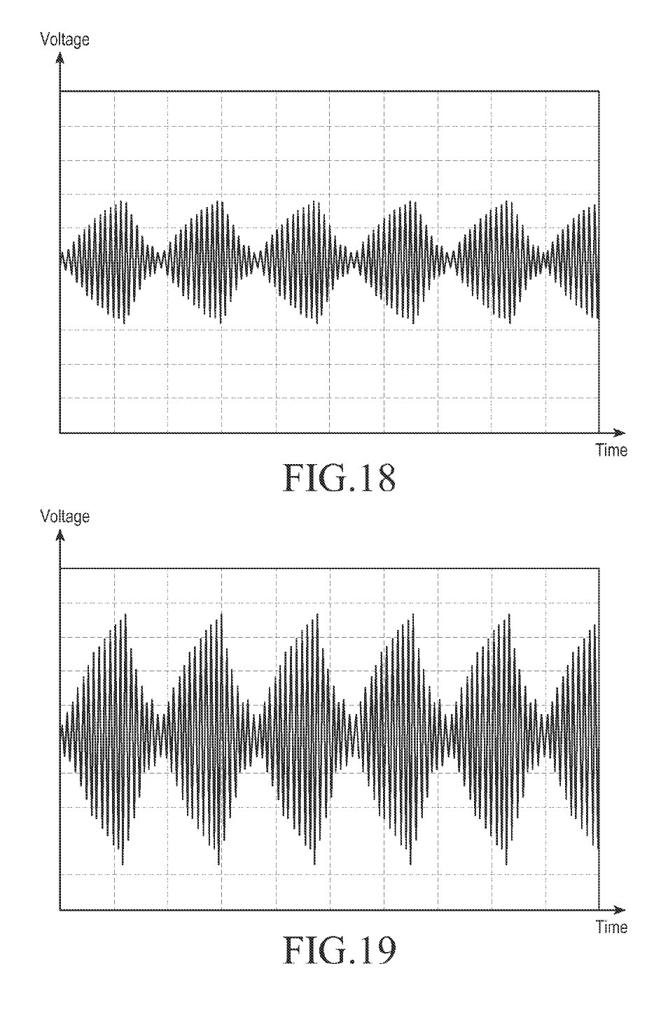

With reference to FIGS. 6, 7 and 8 and FIGS. 12 to 19, a method of providing a haptic effect to an electronic device or an input unit according to an embodiment of the present invention will be described below. The electronic device 100 illustrated in FIG. 1 and the input unit 168 illustrated in FIG. 5 will be referenced in the following description.

FIG. 6 is a flowchart illustrating a method for providing a haptic effect in the electronic device 100 according to an embodiment of the present invention.

Referring to FIG. 6, in step 605, the electronic device 100 detects a touch of the input unit 168 on the touch screen 190.

In step 610, the electronic device 100 calculates a curve angle of a touch trajectory drawn for a predetermined time period.

In step 615, the electronic device 100 transmits a haptic signal, corresponding to the curve angle, to the input unit 168. The curve angle is the angle difference between at least two vectors, each representing changes in touched position on a touch trajectory drawn during one of at least two time periods that make up the predetermined time period. As described above, the angle difference between the two vectors may be calculated using at least three touched positions.

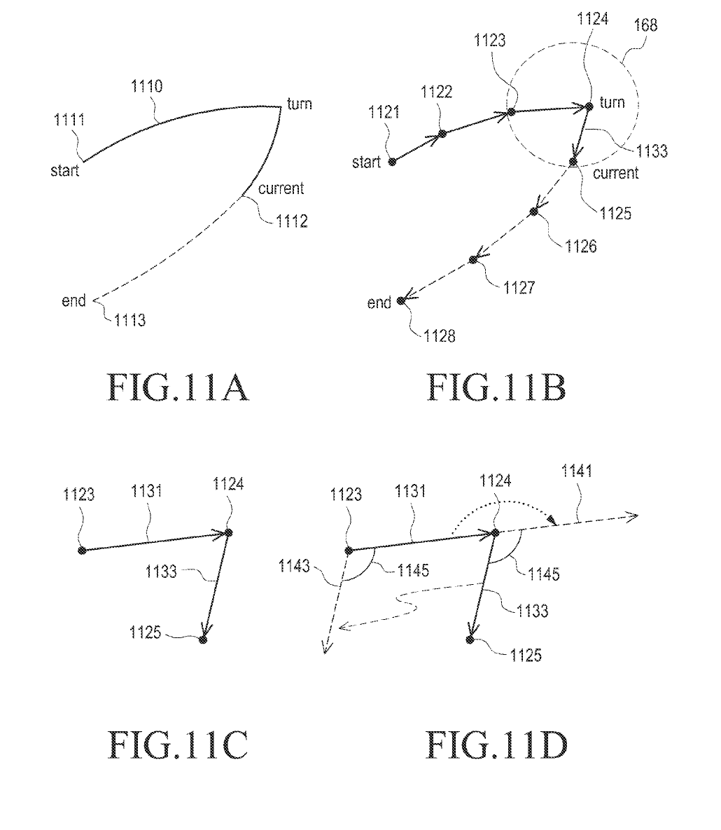

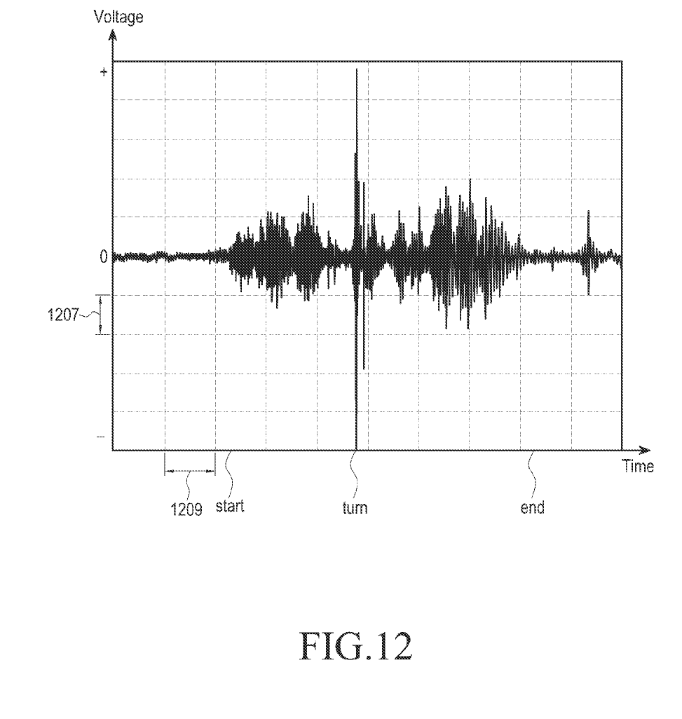

For example, the electronic device 100 transmits a haptic signal to the input unit 168 according to the touch trajectory 1110 running from the starting position 1111 to the ending position 1113 in FIG. 11A. The input unit 168 may control the actuator 520 to vibrate according to the received haptic signal. For example, the vibration strength of the input unit 168 may be determined according to the magnitude of a voltage supplied to the actuator 520. FIG. 12 is a graph illustrating the magnitudes of voltages supplied to the actuator 520 of the input unit 168 with respect to the time axis on which time points of sensing the starting position 1111, the turning position, and the ending position 1113 of the touch of the input unit 168 illustrated in FIG. 11A are defined. Because the curve angle is largest at the time point of sensing the turning position of the touch trajectory 1110 illustrated in FIG. 11A, the vibration strength is greatest at the time point of sensing the turning position. In the graphs illustrated in FIGS. 12, 16, 17, 18 and 19, a grid width 1209 representing time along the X axis may be, for example, 50 ms and a grid length 207 representing the magnitude of a voltage supplied to the actuator 520 of the input unit 168 on the Y axis may be, for example, 0.5V.

In the graph of FIG. 12, a voltage supplied to the actuator 520 of the input unit 168 may be determined as a function of a touch speed or a touch pressure as well as a touch curve angle. For example, the touch curve angle may be heavily weighted, relative to the touch speed or the touch pressure, when being reflected in a haptic effect (e.g., a vibration strength) in FIG. 12.

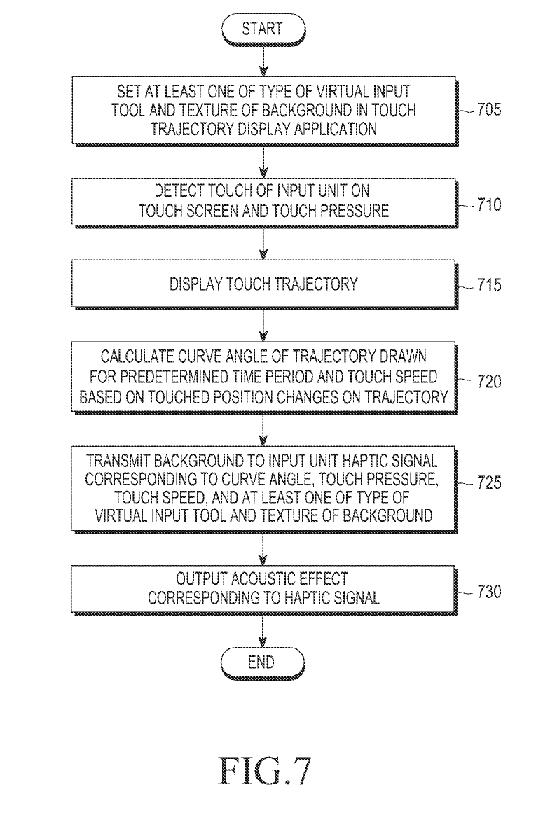

FIG. 7 is a detailed flowchart illustrating a method of providing a haptic effect in the electronic device 100 according to an embodiment of the present invention.

Referring to FIG. 7, in step 705, the electronic device 100 sets at least one of the type of a virtual input tool and the texture of a background on which a touch trajectory is drawn by a touch trajectory display application.

In step 710, the electronic device 100 detects a touch of the input unit 168 on the touch screen 190. The electronic device 100 may determine the position or coordinates of the touch. In addition, the electronic device 100 may detect the pressure of the touch.

In step 715, when the input unit 168 moves the touch on the touch screen 190 of the electronic device 100 according to a user input, the electronic device 100 displays the trajectory of the touch. The electronic device 100 may display an object such as, for example, spots, a line, or a polygon along the touch trajectory. The displayed object may correspond to the type of a virtual input tool.

In step 720, the electronic device 100 calculates a curve angle of the touch trajectory drawn for a predetermined time period. The electronic device 100 may further calculate the speed of the touch based on touched position changes on the touch trajectory.

In step 725, the electronic device 100 generates a haptic signal corresponding to at least one of the curve angle of the touch trajectory, the touch pressure, the touch speed, the type of a virtual input tool, and the texture of a background and transmits the haptic signal to the input unit 168.

In step 730, the electronic device 100 outputs an acoustic effect corresponding to the haptic signal through the speaker 163.

It has been described above, with reference to FIGS. 9A to 10E, that a haptic effect may be provided according to a curve angle of a touch trajectory.

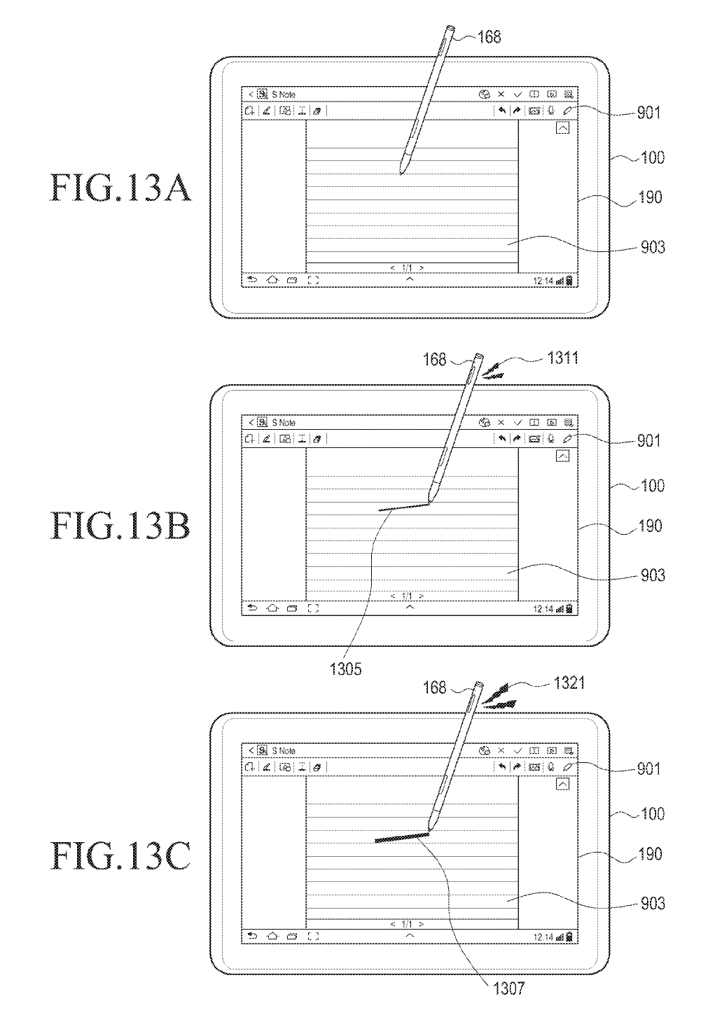

As described above, in step 725, the electronic device 100 may generate a haptic signal according to a touch pressure and may transmit the haptic signal to the input unit 168, thereby providing a haptic effect. The haptic signal may carry information used to control the input unit 168 to vibrate according to a vibration strength corresponding to the detected touch pressure. In FIG. 13A, when the input unit 168 is placed on the touch screen 190, the electronic device 100 senses the touch. When the input unit 168 is moved by a user manipulation, the electronic device 100 may display touch trajectories 1305 and 1307, as illustrated in FIGS. 13B and 13C. For example, the electronic device 100 may differentiate a haptic effect 1311 illustrated in FIG. 13B from a haptic effect 1321 illustrated in FIG. 13C by generating and transmitting haptic signals having different vibration strengths for the input unit 168 according to detected touch pressures. For example, the input unit 168 may vibrate more strongly in response to a larger touch pressure. As illustrated in FIGS. 13B and 13C, the electronic device 100 may control display of the touch trajectories 1305 and 1307 with different line thicknesses according to touch pressures.

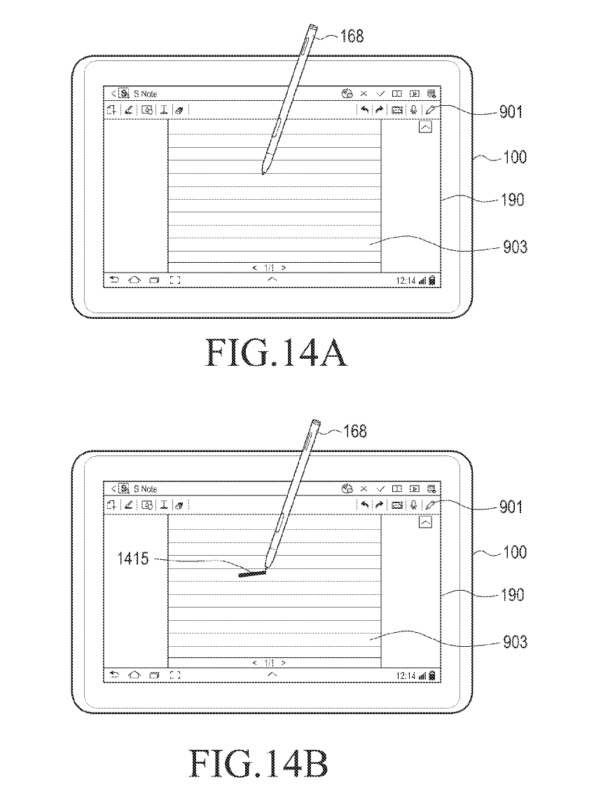

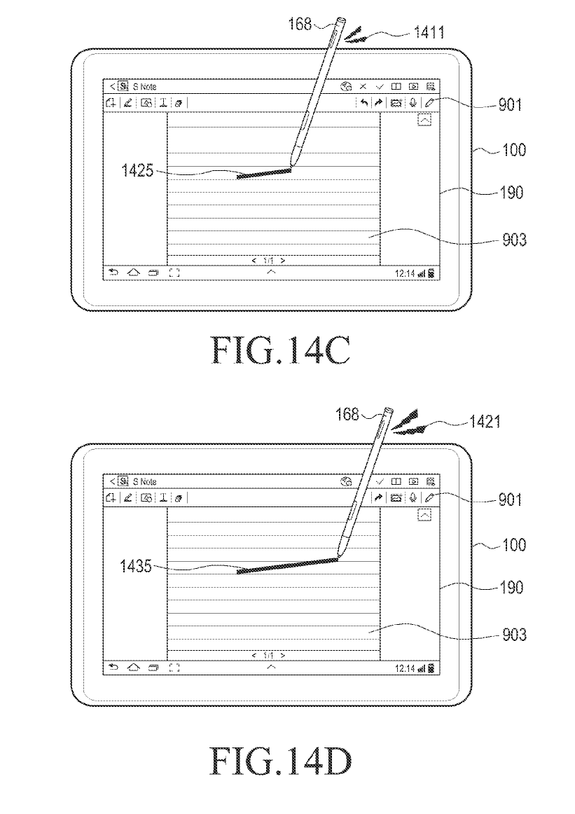

As also described above, in step 725, the electronic device 100 may generate a haptic signal according to a touch speed and may transmit the haptic signal to the input unit 168, thereby providing a haptic effect. The haptic signal may carry information used to control the input unit 168 to vibrate according to a vibration strength corresponding to the detected touch speed. In FIG. 14A, when the input unit 168 is placed on the touch screen 190, the electronic device 100 senses the touch. When the input unit 168 is moved by a user manipulation, the electronic device 100 may display touch trajectories 1415, 1425, and 1435, as illustrated in FIGS. 14B, 14C and 14D, respectively. For example, when the electronic device 100 calculates the speeds of touches for a predetermined time period, it generates and transmits haptic signals having different vibration strengths, according to the touch speeds, to the input unit 168. If a touch speed is less than or equal to a predetermined speed, no haptic effect may be provided as illustrated in FIG. 14B. As illustrated in FIGS. 14C and 14D, the electronic device 100 may determine different vibration strengths for the input unit 168 according to different touch speeds and, thus, may provide different haptic effects 1411 and 1421 to the input unit 168. For example, the input unit 168 may vibrate more strongly in response to a faster touch.

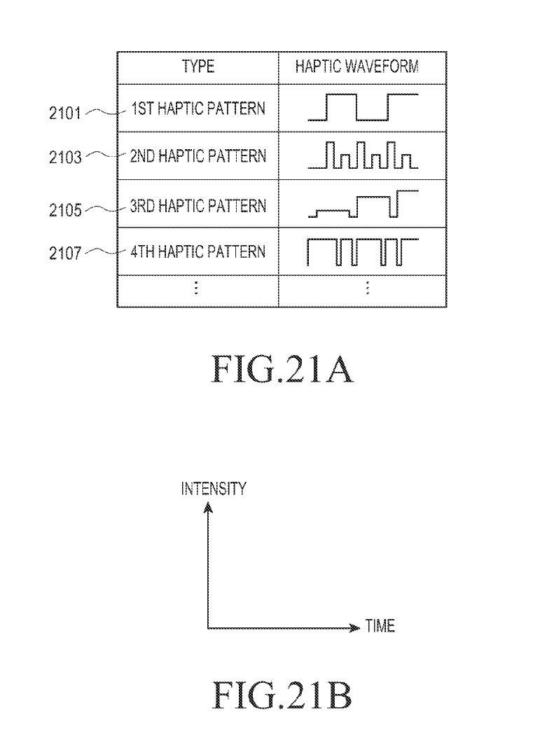

As also described above, in step 725, the electronic device 100 may generate a haptic signal corresponding to at least one selected from the type of a virtual input tool and the texture of a background and may transmit the haptic signal to the input unit 168, thereby providing a haptic effect. The haptic signal may carry information used to control the input unit 168 to vibrate according to a haptic pattern corresponding to at least one of the type of a virtual input tool and the texture of a background. For example, the haptic pattern may be one of first to fourth haptic patterns 2101, 2103, 2105, and 2107 listed in FIG. 21A.

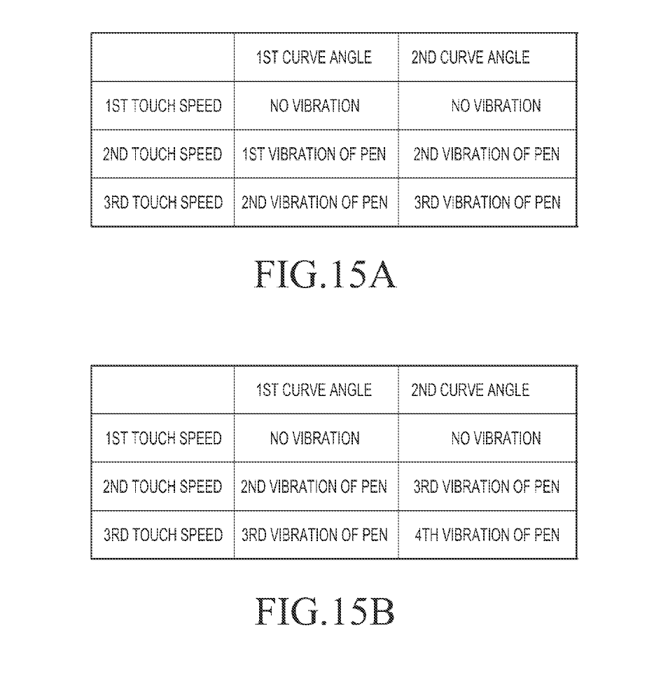

As also described above, in step 725, the electronic device 100 may generate a haptic signal as a function of a curve angle of a touch trajectory, a touch speed, and a touch pressure altogether and transmits the haptic signal to the input unit 168, thereby providing a haptic effect. FIG. 15A illustrates a table that lists vibration strengths for the input unit 168 with respect to curve angles and touch speeds, in the case where a touch pressure is less than a predetermined pressure. FIG. 15B illustrates a table that lists vibration strengths for the input unit 168 with respect to curve angles and touch speeds, in the case where a touch pressure is greater than or equal to the predetermined pressure. The tables illustrated in FIGS. 15A and 15B may be stored in the memory 120 of the electronic device 100. First, second, and third touch speeds refer to predetermined speed ranges derived from touch speeds. Speed values of the speed range corresponding to the second touch speed are greater than or equal to speed values of the speed range corresponding to the first touch speed. Speed values of the speed range corresponding to the third touch speed are greater than or equal to the speed values of the speed range corresponding to the second touch speed. First and second curve angles refer to predetermined angle ranges derived from curve angles of touch trajectories. Angles of the angle range corresponding to the second curve angle are greater than or equal to angles of the angle range corresponding to the first curve angle. In the case of ‘no vibration’ in the tables illustrated in FIGS. 15A and 15B, the electronic device 100 may not generate a haptic signal or may not transmit a haptic signal to the input unit 168. Further, the electronic device 100 may transmit a haptic signal indicating discontinuation of a haptic effect, by the actuator 520, to the input unit 168 according to a setting between the electronic device 100 and the input unit 168.

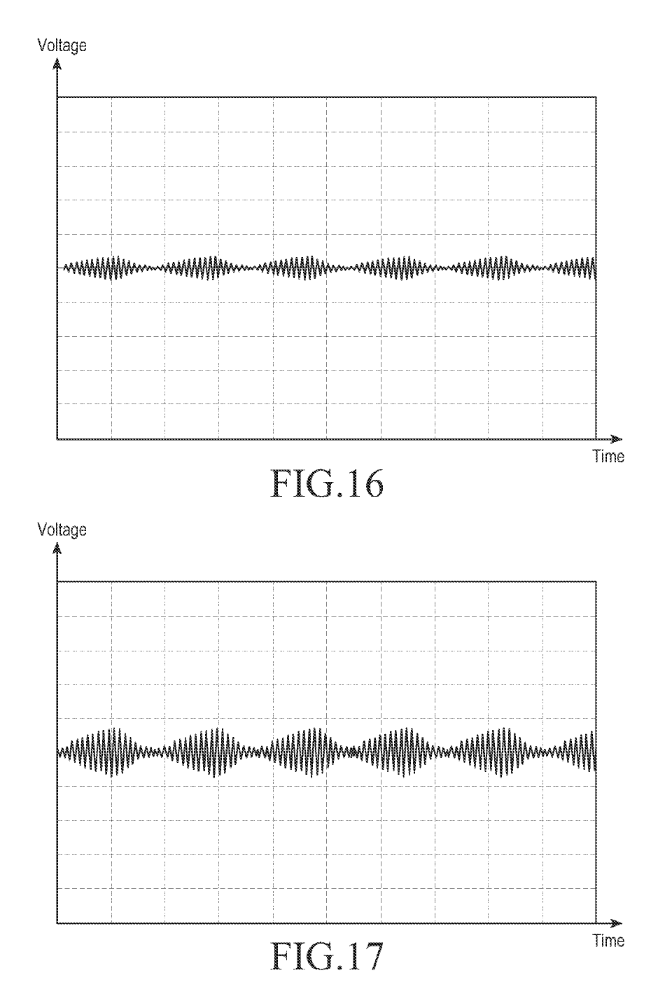

First to fourth vibrations may be identical with respect to a haptic pattern and different with respect to vibration strength. For example, FIGS. 16 to 19 are graphs illustrating the first to fourth vibrations, respectively. Referring to FIGS. 16 to 19, haptic patterns with the first to fourth vibrations have a vibration cycle of 90 ms. For one 90-ms cycle, the magnitude of a voltage (i.e., a vibration strength) supplied to the actuator 520 of the input unit 168 rises for about 0 ms to 60 ms and drops for about 60 ms to 90 ms. In the graphs of FIGS. 16 to 19, the actuator 520 may have a peak voltage of about 0.2V in the first vibration, a peak voltage of about 0.4V in the second vibration, a peak voltage of about 0.8V in the third vibration, and a peak voltage of about 1.8V in the fourth vibration.

The first to fourth vibrations listed in the tables of FIGS. 15A and 15B may represent different haptic patterns.

As described above, in step 725, the electronic device 100 may generate a haptic signal as a function of at least one of a curve angle of a touch trajectory, a touch pressure, a touch speed, the type of a virtual input tool, and the texture of a background and may transmit the haptic signal to the input unit 168, thereby providing a haptic effect. The haptic signal may include information used to control the input unit 168 to vibrate according to a vibration strength and a haptic pattern. The vibration strength may correspond to the curve angle, the touch pressure, and the touch speed, whereas the haptic pattern may correspond to at least one of the type of a virtual input tool and the texture of a background on which a touch trajectory is drawn, as set by a touch trajectory display application. For example, the haptic signal or the control information for vibration of the input unit 168 may be generated based on the tables of FIGS. 15A and 15B or may be determined by Equation (1).

Y(t)=α*β*∈*a(t) (1)

In Equation (1), Y(t) represents the control information used to control vibration of the input unit 168, α is a variable corresponding to the touch pressure, β is a variable corresponding to the touch speed, ∈ is a variable corresponding to the curve angle, and a(t) represents a haptic pattern corresponding to at least one of the type of a virtual input tool and the texture of a background according to a setting, which is a vibration strength at time t.

It will be readily understood to those skilled in the art that factors affecting control information for vibration of the input unit 168, such as a touch pressure, a touch speed, a curve angle of a touch trajectory, the type of a virtual input tool, and the texture of a background may be used in various combinations or may be applied by modifying the foregoing tables or equation.

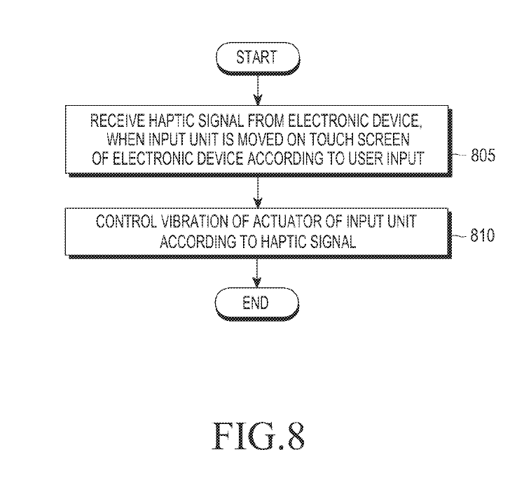

FIG. 8 is a flowchart illustrating a method of providing a haptic effect in the input unit 168 according to an embodiment of the present invention.

Referring to FIG. 8, in step 805, when the input unit 168 is moved on the touch screen 190 of the electronic device 100 according to a user input, the input unit 168 receives a haptic signal corresponding to the trajectory of the touch from the electronic device 100.

The memory 570 of the input unit 168 stores at least one predetermined haptic pattern.

In step 810, the input unit 168 controls the actuator 510 to vibrate according to the haptic signal. The haptic signal may include information used to control vibration of the actuator 510 according to a curve angle of a touch trajectory drawn for a predetermined time period.

The input unit 168 accesses a haptic pattern corresponding to the haptic signal in the memory 570 and controls the actuator 510 to vibrate according to the accessed haptic pattern. The haptic signal may include the index of the haptic pattern. Each of the electronic device 100 and the input unit 168 may pre-store a mapping table that maps an index to at least one haptic pattern.

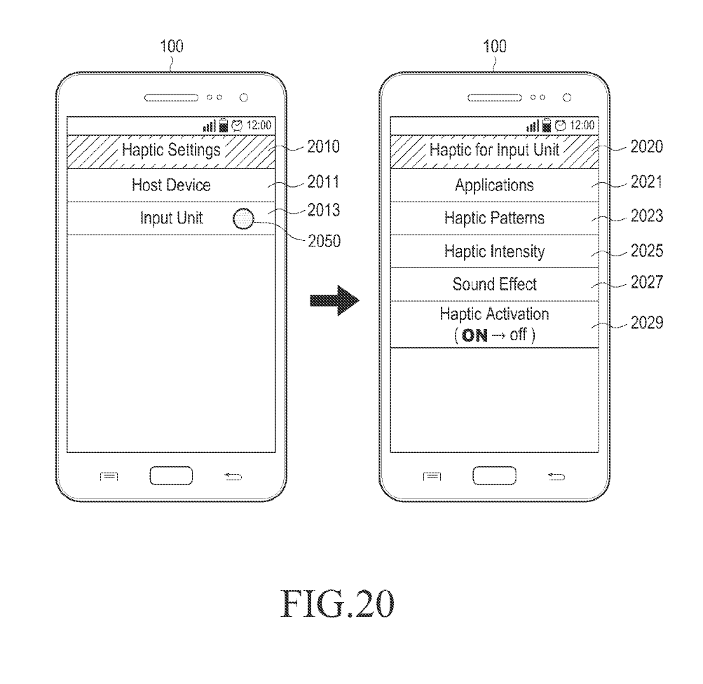

Now a description will be given of the UI that allows a user to set a haptic effect for the input unit 168 with reference to FIGS. 20, 21A, and 21B.

FIG. 20 illustrates a haptic setting UI according to an embodiment of the present invention.

A Haptic Settings menu 2010 may be displayed on a screen of the electronic device 100. The Haptic Settings menu 2010 may include a Host Device menu item 2011 and an Input Unit menu item 2013. When the Input Unit menu item 2013 is selected by a user input 2050, a Haptic for Input Unit menu 2020 may be displayed on a screen of the electronic device 100. The Haptic for Input Unit menu 2020 may include an Applications menu item 2021, a Haptic Patterns menu item 2023, a Haptic Intensity menu item 2025, a Sound Effect menu item 2027, and/or a Haptic Activation menu item 2029.

When the Applications menu item 2021 is selected by a user input, a list of applications may be displayed and a UI may be provided for each of the applications so that the user may determine whether to receive a haptic effect when the application is executed. In addition, the user may determine whether to receive a haptic effect for the all applications on the UI.

The Haptic Patterns menu item 2023, the Haptic Intensity 2025, or the Sound Effect menu item 2027 may be provided for a specific application, in conjunction with the Applications menu item 2021. For example, if a specific application requires an elaborate input by the input unit 168, the user may set a weak haptic intensity through a UI that allows haptic intensity control or may deactivate a haptic effect, for that specific application.

The Haptic Patterns menu item 2023 may allow the user to select at least one haptic pattern to receive through the input unit 168 from the list of haptic patterns. For example, if the Haptic Patterns menu item 2023 is selected, the first to fourth haptic patterns 2101 to 2107 illustrated in FIG. 21A may be tabulated along with their haptic waveforms on a screen. FIG. 21A illustrates the haptic waveforms of the first to fourth haptic patterns 2101 to 2107 and FIG. 21B illustrates time on the X axis and haptic intensity (i.e., vibration strength) on the Y axis in the waveform of a haptic pattern. The present invention is not limited to the first to first to fourth haptic patterns 2101 to 2107 illustrated in FIG. 21A and may include many other haptic waveforms. For example, haptic patterns perceived by the user may be provided, such as a haptic pattern simulating vibrations or a tactile feeling felt when a user is sawing, a haptic pattern that gives gentle feelings to the user with weak vibrations of a long cycle, a haptic pattern that gives strong feelings to the user with strong vibrations of a short cycle, a haptic pattern simulating vibrations or a tactile feeling felt when the user scratches a rough surface such as a wall, and the like.

Upon selection of the Haptic Intensity menu item 2025, the electronic device 100 may provide a UI with haptic waveforms, on which the user may readily adjust a haptic intensity by a touch.

Upon selection of the Sound Effect menu item 2027, the electronic device 100 may provide a UI on which the user may map a sound to each waveform, or may activate or deactivate a sound effect according to a user input.

The Haptic Activation menu item 2029 indicates whether a haptic effect is active or inactive for the input unit 168 or allows the user to activate or deactivate a haptic effect for the input unit 168. For example, in FIG. 20, the Haptic Activation menu item 2029 is set to ON, indicating that a haptic effect is active for the input unit 168. Upon selection of the Haptic Activation menu item 2029 by a touch gesture or the like, the Haptic Activation menu item 2029 is toggled between ON and OFF.

It is to be understood that the haptic setting UI may be configured in various manners according to a user intention or user convenience.

The steps of the methods of providing a haptic effect in FIGS. 6 and 7 may be performed in a different sequence and some of the steps may be omitted. Further, some of the steps may be performed in combination. Various UIs may be configured by modifying the steps or omitting some of the steps.

The methods of providing a haptic effect in FIGS. 6, 7, and 8 may be implemented in hardware, software, or a combination thereof. The methods of providing a haptic effect in FIGS. 6, 7, and 8 may be written to a recording medium and may be downloaded to the electronic device or the input unit from a server or a computer over a communication network.

As is apparent from the above description of the present invention, since a signal that controls a haptic effect for an input unit is based on a touch trajectory, a user can experience a more realistic feeling in dealing with a virtual input tool.

A haptic effect is controlled for the input unit based on at least one of a touch pressure, a touch speed, and a curve angle of a touch trajectory. Therefore, a more elaborate and more accurate haptic response is provided to the user.

Furthermore, user convenience can be increased by providing a UI that enables a user to set a haptic effect for the input unit.

It should be noted that the embodiments of the present invention, as described above, typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the embodiments of the present invention as described above. Alternatively, one or more processors operating in accordance with stored instructions may implement the functions associated with the embodiments of the present invention as described above. Such instructions may be stored on one or more processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present invention can be easily construed by programmers skilled in the art to which the present invention pertains.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A method for providing, by an electronic device, a haptic effect using an input unit, the method comprising:
detecting a touch of the input unit on a touch screen of the electronic device;
displaying a trajectory of the touch;
calculating a curve angle of the touch trajectory drawn for a predetermined time period; and
transmitting a haptic signal, corresponding to the curve angle, to the input unit.

2. The method of claim 1, wherein the curve angle is an angle difference between at least two vectors, each of which represents touched position changes on a touch trajectory drawn for one of at least two time periods derived from the predetermined time period.

3. The method of claim 1, wherein the predetermined time period includes an (N−1)^{th} time period and an N^{th} time period and N is an integer larger than 0, and
wherein the curve angle is an angle difference between an (N−1)^{th} vector representing touched position changes on a touch trajectory drawn for the (N−1)^{th} time period and an N^{th} vector representing touched position changes on a touch trajectory drawn for the N^{th} time period.

4. The method of claim 3, wherein the N^{th} vector is obtained based on a current touched position detected at a most recent time, the (N−1)^{th} vector is stored in a memory of the electronic device before the N^{th} vector is obtained, and the N^{th} time period and the (N−1)^{th} time period are contiguous on a time axis.

5. The method of claim 1, wherein the haptic signal includes information used to control vibration of the input unit according to a vibration strength corresponding to the curve angle.

6. The method of claim 1, wherein the touch detection comprises detecting a pressure of the touch, and
wherein the haptic signal includes information used to control vibration of the input unit according to a vibration strength corresponding to the detected touch pressure.

7. The method of claim 1, further comprising calculating a speed of the touch based on touched position changes on the touch trajectory,
wherein the haptic signal includes information used to control vibration of the input unit according to a vibration strength corresponding to the calculated touch speed.

8. The method of claim 1, further comprising setting at least one of a type of a virtual input tool and a texture of a background on which the touch trajectory is displayed, in a touch trajectory display application,
wherein the haptic signal includes information used to control vibration of the input unit according to a haptic pattern corresponding to the at least one of the type of the virtual input tool and the texture of the background.

9. The method of claim 1, wherein the haptic signal includes information that controls vibration of the input unit according to a vibration strength and a haptic pattern, and
wherein the vibration strength corresponds to the curve angle, a touch pressure, and a touch speed and the haptic pattern corresponds to at least one of a type of a virtual input tool and a texture of a background on which the touch trajectory is displayed, set in a touch trajectory display application.

10. The method of claim 9, wherein the information that controls vibration of the input unit is acquired:
Y(t)=α*β*∈*a(t)
where Y(t) represents the control information, α is a variable corresponding to the touch pressure, β is a variable corresponding to the touch speed, ∈ is a variable corresponding to the curve angle, and a(t) represents the haptic pattern indicating a vibration strength at time t.

11. The method of claim 1, wherein the haptic signal includes an index of at least one haptic pattern representing a pattern of vibration strengths over time.

12. The method of claim 11, wherein the haptic signal further includes at least one of a vibration duration of the input unit, an offset of the haptic pattern, a starting vibration strength, an ending vibration strength, a vibration-on command, and a vibration-off command.

13. The method of claim 1, wherein the input unit includes at least one of a capacitive pen and an electromagnetic inductive pen.

14. The method of claim 1, further comprising outputting an acoustic effect corresponding to the haptic signal.

15. A method for providing, by an electronic device, a haptic effect using an input unit, the method comprising:
detecting a touch of the input unit on a touch screen of the electronic device;
calculating a curve angle of a trajectory of the touch drawn for a predetermined time period; and
transmitting a haptic signal, corresponding to the curve angle, to the input unit,
wherein the curve angle is an angle difference between at least two vectors, each of which represents touched position changes on a touch trajectory drawn during one of at least two time periods derived from the predetermined time period.

16. A method for providing a haptic effect in an input unit under control of an electronic device, the method comprising:
receiving a haptic signal, corresponding to a touch trajectory, from the electronic device, when the input unit is moved on a touch screen of the electronic device according to a user input; and
controlling an actuator of the input unit to vibrate according to the haptic signal,
wherein the haptic signal includes information used to control vibration according to a curve angle of the touch trajectory drawn for a predetermined time period.

17. An apparatus for providing a haptic effect using an input unit, the apparatus comprising:
a touch screen configured to detect a touch of the input unit and to display a trajectory of the touch;
a controller configured to calculate a curve angle of the touch trajectory drawn for a predetermined time period; and
a communication unit configured to transmit a haptic signal, corresponding to the curve angle, to the input unit.

18. The apparatus of claim 17, wherein the curve angle is an angle difference between at least two vectors, each of which represents touched position changes on a touch trajectory drawn for one of at least two time periods derived from the predetermined time period.

19. The apparatus of claim 17, wherein the predetermined time period includes an (N−1)^{th} time period and an N^{th} time period and N is an integer larger than 0, and
wherein the curve angle is an angle difference between an (N−1)^{th} vector representing touched position changes on a touch trajectory drawn for the (N−1)^{th} time period and an N^{th} vector representing touched position changes on a touch trajectory drawn for the N^{th} time period.

20. The apparatus of claim 19, further comprising a memory configured to store the (N−1)^{th} vector before the N^{th} vector is obtained,
wherein the controller obtains the N^{th} vector based on a current touched position detected at a most recent time, accesses the (N−1)^{th} vector of the N^{th} time period contiguous to the (N−1)^{th} time period on a time axis, and calculates the angle difference between the N^{th} vector and the (N−1)^{th} vector.

21. The apparatus of claim 17, wherein the haptic signal includes information used to control vibration of the input unit according to a vibration strength corresponding to the curve angle.

22. The apparatus of claim 17, wherein the touch screen detects a touch pressure, and
wherein the haptic signal includes information used to control vibration of the input unit according to a vibration strength corresponding to the detected touch pressure.

23. The apparatus of claim 17, wherein the controller calculates a touch speed based on touched position changes on the touch trajectory, and
wherein the haptic signal includes information used to control vibration of the input unit according to a vibration strength corresponding to the calculated touch speed.

24. The apparatus of claim 17, wherein the touch screen sets at least one of a type of a virtual input tool and a texture of a background on which the touch trajectory is displayed, in a touch trajectory display application, and
wherein the haptic signal includes information used to control vibration of the input unit according to a haptic pattern corresponding to the at least one of the type of the virtual input tool and the texture of the background.

25. The apparatus of claim 17, wherein the haptic signal includes information used to control vibration of the input unit according to a vibration strength and a haptic pattern, and
wherein the vibration strength corresponds to the curve angle, a touch pressure, and a touch speed and the haptic pattern corresponds to at least one of a type of a virtual input tool and a texture of a background on which the touch trajectory is displayed, set in a touch trajectory display application.

26. The apparatus of claim 25, wherein the information used to control vibration of the input unit is acquired by:
Y(t)=α*β*∈*a(t)
where Y(t) represents the control information, α is a variable corresponding to the touch pressure, β is a variable corresponding to the touch speed, ∈ is a variable corresponding to the curve angle, and a(t) represents the haptic pattern indicating a vibration strength at time t.

27. The apparatus of claim 17, wherein the haptic signal includes an index of at least one haptic pattern representing a pattern of vibration strengths over time.

28. The apparatus of claim 27, wherein the haptic signal further includes at least one of a vibration duration of the input unit, an offset of the haptic pattern, a starting vibration strength, an ending vibration strength, a vibration-on command, and a vibration-off command.

29. The apparatus of claim 17, wherein the input unit includes at least one of a capacitive pen and an electromagnetic inductive pen.

30. The apparatus of claim 17, wherein the controller controls output of an acoustic effect corresponding to the haptic signal.

31. An apparatus for providing a haptic effect using an input unit, the apparatus comprising:
a touch screen configured to detect a touch of the input unit on a touch screen of the electronic device;
a controller configured to calculate a curve angle of a trajectory of the touch drawn for a predetermined time period; and
a communication unit configured to transmit a haptic signal corresponding to the curve angle to the input unit,
wherein the curve angle is an angle difference between at least two vectors, each of which represents touched position changes on a touch trajectory drawn during one of at least two time periods derived from the predetermined time period.

32. An input unit for providing a haptic effect under control of an electronic device, the input unit comprising:
a communication unit configured to receive a haptic signal, corresponding to a touch trajectory, from the electronic device, when the input unit is moved on a touch screen of the electronic device according to a user input;
an actuator configured to vibrate; and
a controller configured to control vibration of the actuator according to the haptic signal,
wherein the haptic signal includes information used to control vibration according to a curve angle of the touch trajectory drawn for a predetermined time period.

33. The input unit of claim 32, further comprising a memory configured to store at least one preset haptic pattern,
wherein the controller accesses the at least one preset haptic pattern corresponding to the haptic signal in the memory and controls vibration of the actuator according to the accessed haptic pattern.
